(19) United States
(12) Patent Application Publication
(10) Pub. No.: US 2009/0190449 A1
(43) Pub. Date: Jul. 30, 2009

(54) OPTICAL HEAD TRANSFER DEVICE, INTEGRATED CIRCUIT FOR OPTICAL HEAD TRANSFER DEVICE, FOCUSING LENS DRIVING DEVICE, AND INTEGRATED CIRCUIT FOR FOCUSING LENS DRIVING DEVICE

(76) Inventors: Shin-ichi Yamada, Osaka (JP); Hiroshige Ishibashi, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/302,966

(22) PCT Filed: May 25, 2007
(86) PCT No.: PCT/JP2007/060693

§ 371 Date: Dec. 1, 2008

(30) Foreign Application Priority Data
May 30, 2006 (JP) 2006-149182

(51) Int. Cl. G11B 7/00

(52) U.S. Cl. 369/44.32; 369/112.23; G9B/7

(57) ABSTRACT

When transferring an optical head in a radial direction of an optical disc, the optical head is initially transferred with a speed profile of a larger acceleration, and when abnormality is detected by an abnormality detection circuit which detects abnormality of a focus control system, the optical head is again transferred with a speed profile of a smaller acceleration, whereby preventing a movable part of a lens actuator from colliding with a fixed part when transferring the optical head in the radial direction of the optical disc, resulting in an optical head transfer device, an integrated circuit for the optical head transfer device, a focusing lens driving device, and an integrated circuit for the focusing lens driving device which can avoid an increase in the start-up time of the device, a reduction in the data reading speed from the optical disc, and the like.

### TECHNICAL FIELD

The present invention relates to an optical head transfer device for transferring an optical head which reproduces or records information along a radius direction of an optical disc, in an optical disc device which reproduces and records information from/in the optical disc, and an integrated circuit for the optical head transfer device.

### BACKGROUND ART

A digital versatile disc (DVD) is known as an optical disc capable of recording a large volume of data because it can record digital information with a recording density about six times as that of a compact disc (CD). In recent years, with an increase in the amount of information to be recorded in an optical disc, a larger capacity optical disc has been demanded. In order to increase the capacity of an optical disc, it is necessary to increase the information recording density by reducing the size of a light spot which is formed by light incident on the optical disc, when recording information in the optical disc or when reproducing information recorded in the optical disc. The light spot can be reduced in size by shortening the wavelength of laser light emitted from a light source and increasing the numerical aperture (NA) of a focusing lens. A light source having a wavelength of 660 nm and a focusing lens having a numerical aperture (NA) of 0.6 are used for DVD. For example, a recording density five times as that of the existing DVD can be achieved by using a blue laser having a wavelength of 405 nm and a focusing lens having a NA of 0.85.

By the way, to provide a compatible function with existing optical discs in an optical disc device which realizes high-density recording/reproduction using a short-wavelength laser as a blue laser further enhances the usability of the device and improves the cost performance. In this case, since it is difficult to increase the working distance of the focusing lens like the working distance of the focusing lens used for DVD or CD with increasing its numerical aperture to 0.85, there is proposed, as a compatible optical disc device capable of performing high-density recording/reproduction, an optical disc device using an optical head which is provided with at least one focusing lens used for recording and reproducing CD or DVD and is also separately provided with a focusing lens for performing high-density recording that has a higher numerical aperture than the above focusing lens.

Next, the working distance will be described. In an optical head, a working distance (WD) for tolerating surface vibration of the optical disc is required between the focusing lens and the optical disc, and this working distance is determined according to the thickness of the optical disc, the numerical aperture of the focusing lens, and the like.

By the way, as a prior art of a focusing lens actuator having a plurality of focusing lenses mounted on its movable part, the following device has been proposed. In order to deal with a difference in the working distances of the first optical disc and the second optical disc having different thicknesses, the positions in the focusing direction of the first focusing lens and the second focusing lens provided on the movable part of the lens actuator are made different from each other. For example, it is assumed that, as shown in FIG. 21, the WD between the first optical disc and the first focusing lens 10 is shorter than the WD between the second optical disc and the second focusing lens 22, and the second optical disc is loaded in the optical head transfer apparatus. In this case, the first focusing lens 10 might collide with the optical disc when focus control is operated using the second focusing lens 22. Therefore, it is difficult to make the difference in the positions of the first focusing lens 10 and the second focusing lens 22 in the focusing direction equal to the difference in the working distances.

The first focusing lens 10, the second focusing lens 22, and a lens holder 350 are movable elements, and these elements constitute the movable part 2.

Therefore, as shown in FIG. 22, it is constructed such that the difference in the positions of the first focusing lens 10 and the second focusing lens 22 in the focusing direction is made shorter than the difference in the working distances, and the positions of the movable part in the state where the focus control is operated (referred to as neutral positions) are respectively made different from the reference position. That is, it is constructed such that the neutral position of the movable part 2 in the first optical disc (referred to as a first neutral position) and the neutral position of the movable part 2 in the second optical disc (referred to as a second neutral position) are made different from each other.

In such construction, however, a wire which connects the movable part 2 in the focus control state and the fixed part tilts in the focusing direction. Therefore, the movable part 2 is likely to roll when the optical head is transferred in the radial direction of the optical disc. Further, since the movable part 2 held by the wire tends to remain at its position due to its inertial force, it is vibrated in the radial direction of the optical disc at the inherent resonance frequency of the lens actuator.

Further, displacement of the movable part 2 in the radial direction of the optical disc may cause a torsion in the wire or the like, and thus the movable part 2 might tilt in the rotation direction around the tangential direction of the optical disc. Since the movable part 2 is significantly displaced due to its tilting, rolling, or vibration at the inherent resonance frequency, it might collide with the fixed part. If the movable part 2 collides with the fixed part, the focus control system enters the abnormal state due to the impact of the collision.

There is a case where the position of the movable part 2 might deviate in the radial direction of the optical disc due to such as a deviation in the wire attachment position which may occur when manufacturing the lens actuator. In such case, the movable part 2 deviates from the center of the movable range. Further, depending on the installation direction of the optical disc device, the movable part 2 deviates in the radial direction of the optical disc due to its own weight, and thus the movable part 2 deviates from the center of the movable range. In such case, since one side of the movable range is narrowed, the movable part 2 becomes more likely to collide with the fixed part.

If the focus control system is in the abnormal state, such as restarting of the optical head transfer device is required, which causes an increase in the start-up time of the device, a reduction in the data reading speed from the optical disc, and the like.

Further, while the above description has been made of the optical disc device using the optical head which is provided with at least one focusing lens used for recording and reproducing CD or DVD and is also separately provided with a focusing lens for performing high-density recording that has a higher numerical aperture than the above focusing lens in order to increase the working distance like the working distance of the focusing lens for DVD or CD with increasing its numerical aperture to 0.85, there is proposed an optical disc device using an optical head which deals with recording and reproduction of CD, DVD, and high-density recording optical disc using one focusing lens by making the working distance thereof shorter than that of the focusing lens for DVD or CD.

The optical head used in this optical disc device will be described with reference to FIG. 23.

FIG. 23(a) shows an optical head 540, an optical disc 500, a disc motor 4, and a turntable 510 in the case where a high-density recording optical disc 500 is loaded. The optical head 540 is constituted by light sources 501 and 502, optical elements 503, 504, and 507, a relay lens 505, a coupling lens 506, a ¼ wavelength plate, a focusing lens 508, a focusing coil 533, a lens holder 534, and a photodetector 511.

In the optical disc 500, the thickness of a light transmissive layer from a light incident surface to an information surface 509 is about 0.1 mm. The optical disc 500 is loaded on the turntable 510 attached to a motor 4.

A light beam having a wavelength of 405 nm which is emitted from the light source 502 such as a semiconductor laser is incident on the optical element 504. The optical element 504 functions as a deflection beam splitter for the light beam of 405 nm to reflect the light beam. The light beam passing through the optical element 504 is incident on the optical element 503 through the relay lens 505. The optical element 503 is designed to reflect the light beam of 405 nm, and the light beam is projected onto the information surface 509 of the optical disc 500 through the coupling lens 506, the ¼ wavelength plate 8, the optical element 507, and the focusing lens 508.

The reflected light from the information surface 509 of the optical disc 500 is incident on the optical element 503 through the focusing lens 508, the optical element 507, the ¼ wavelength plate 8, and the coupling lens 506. The optical element 503 is designed to reflect the light beam of 405 nm, and the light beam is incident on the optical element 504 through the relay lens 505. The optical element 504 functions as a deflection beam splitter for the light beam of 405 nm to transmit the light beam. The light beam of 405 nm transmitted through the optical element 504 is incident on the photodetector 511.

The lens actuator 532 is constituted by the lens holder 534 having the focusing coil 533, and a fixed part (not shown) having a permanent magnet. A focusing lens 508 is attached to the lens holder 534. The lens holder 534, the focusing lens 508, and the focusing coil 533 are movable parts. The lens actuator 532 varies the relative position of the focusing lens 508 to the permanent magnet of the fixed part with utilizing an electromagnetic force which occurs according to a current flowing through the focusing coil 533, thereby making the focus of the light beam move in the focusing direction (vertical direction in the figure).

Further, the lens actuator 532 varies the relative position of the focusing lens 508 to the permanent magnet of the fixed part by utilizing an electromagnetic force which occurs according to a current flowing through a tracking coil (not shown) of the lens holder 534, thereby making the light beam move in the radial direction of the optical disc 500, i.e., in the direction that traverses the track.

The optical element 507 serves as a filter using a dielectric multilayer. The optical element 507 will be described with reference to FIG. 24.

The optical element 507 is constituted by four regions 550, 551, 552, and 553 having different transmissivity characteristics to the wavelength of the incident light beam. The regions 550, 551, and 552 are separated by concentric circles. The region 550 is a region which transmits light beams of 405 nm, 650 nm, and 780 nm. The region 551 is a region which transmits the light beams of 405 nm and 650 nm and blocks the light beam of 780 nm. The region 552 is a region which transmits the light beam of 405 nm and blocks the light beams of 650 nm and 780 nm. The region 553 is a region which blocks the light beams of all the wavelengths.

Accordingly, the beam diameter of the light beam incident on the focusing lens 508 is restricted by these regions 550 to 553. That is, the diameter of the light beam of 405 nm is larger than the diameter of the light beam of 650 nm, and the diameter of the light beam of 780 nm is smaller than the diameter of the light beam of 650 nm. When the high-density recording optical disc 500 is loaded, a numerical aperture of 0.85 is realized by the light source 502 of 405 nm and the optical element 507.

FIG. 23(b) shows the case where a CD 520 is loaded. In the optical disc 520, the thickness of a light transmissive layer from a light incident surface to an information surface 521 is about 1.2 mm. The optical disc 520 is loaded on the turntable 510 attached to the motor 4. A light beam having a wavelength of 780 nm which is emitted from the light source 501 such as a semiconductor laser is incident on the optical element 503. The optical element 503 functions as a deflection beam splitter for the light beam of 780 nm to transmit the light beam. The light beam passing through the optical element 503 is projected onto the information surface 521 of the optical disc 520 through the coupling lens 506, the ¼ wavelength plate 8, the optical element 507, and the focusing lens 508.

When the CD 520 is loaded, a numerical aperture of 0.45 is realized by the light source 501 of 780 nm and the optical element 507.

The reflected light from the information surface 521 of the optical disc 520 is incident on the optical element 503 through the focusing lens 508, the optical element 507, the ¼ wavelength plate 8, and the coupling lens 506. The optical element 503 functions as a deflection beam splitter for the light beam of 780 nm to reflect the light beam. The light beam reflected by the optical element 503 is incident on the optical element 504 through the relay lens 505. The optical element 504 is designed to transmit the light beam of 780. The light beam of 780 nm transmitted through the optical element 504 is incident on the photodetector 511.

The thickness of the light transmissive layer of the high-density recording optical disc 500 from the light incident surface to the information surface 509 is about 0.1 mm, and the thickness of the light transmissive layer of the CD 520 from the light incident surface to the information surface 521 is about 1.2 mm. Further, the position of the turntable 510 is fixed. Accordingly, the focusing lens 508 is located at a position 531 when the high-density recording optical disc 500 is loaded, while it is located at a position 530 when the CD 520 is loaded. That is, the focusing lens 508 is closer to the light incident surface of the optical disc by a distance L in the case of the CD 520 than in the case of the high-density recording optical disc 500. In FIG. 23, it is displaced upward. The distance L is about 0.7 mm when the refractive index of the light transmissive layer is 1.5.

When a DVD is loaded, a light beam having a wavelength of 650 nm is emitted from the light source 501. The light source 501 has two light sources of 780 nm and 650 nm. The transmission and reflection of the light beam are identical to those described for the wavelength of 780 nm. When the DVD is loaded, a numerical aperture of 0.6 is realized by the light source 501 of 650 nm and the optical element 507. The position of the focusing lens 508 is intermediate between the position in the case of the high-density recording optical disc 500 and the position in the case of the CD 520.

As described above, the wire connecting the fixed part and the movable part having the focusing lens 508 in the focus control state tilts in the focus direction, as in the optical head which is provided with at least one focusing lens used for recording and reproducing CD or DVD and is also separately provided with a focusing lens for performing high-density recording that has a higher numerical aperture than the above focusing lens. Accordingly, there may arise similar problems as those in the optical head which is provided with at least one focusing lens used for recording and reproducing CD or DVD and is also separately provided with a focusing lens for performing high-density recording which has a higher numerical aperture than the above focusing lens.

Patent Document 1: Japanese Published Patent Application No. 2005-302163

Patent Document 2: Japanese Published Patent Application No.

### DISCLOSURE OF THE INVENTION

### Problems to be Solved by the Invention

Accordingly, the present invention is made in view of the above-described problems and has for its object to provide an optical head transfer device, an integrated circuit for the optical head transfer device, a focusing lens driving device, and an integrated circuit for the focusing lens driving device, which can prevent a movable part of a lens actuator from colliding with a fixed part when an optical head is transferred in the radial direction of an optical disc, thereby to avoid an increase in the start-up time of the device, a reduction in the data reading speed from the optical disc, and the like.

### Measures to Solve the Problems

In order to achieve the above-described object, there is provided an optical head transfer device for transferring an optical head which projects a light beam onto an information surface of an optical disc through a focusing lens which is selected among a plurality of focusing lenses which are held by a movable part, as one corresponding to the thickness of a light transmissive layer of the optical disc, comprising: a focus control means for displacing the movable part so that the focusing state of the light beam is in a predetermined state; a displacement means for displacing the movable part so that the light beam traverses tracks formed on the information surface; a transfer means for transferring the displacement means in the radial direction of the optical disc; and an abnormality detection means for detecting abnormality of the focus control means; wherein the acceleration of the transfer means is lowered when abnormality of the focus control means is detected by the abnormality detection means while driving the transfer means.

According to Claim 2 of the present invention, there is provided an optical head transfer device for transferring an optical head which projects a light beam onto an information surface of an optical disc through a focusing lens which is selected among a plurality of focusing lenses which are held by a movable part, as one corresponding to the thickness of a light transmissive layer of the optical disc, comprising: a focus control means for displacing the movable part so that the focusing state of the light beam is in a predetermined state; a displacement means for displacing the movable part so that the light beam traverses tracks formed on the information surface; a transfer means for transferring the displacement means in the radial direction of the optical disc; and a displacement amount control means for detecting a displacement amount of the movable part in the radial direction of the optical disc so as to decrease the displacement amount of the movable part; wherein the transfer means is driven in a state where the displacement amount control means is operated.

According to Claim 3 of the present invention, there is provided an optical head transfer device for transferring an optical head which projects a light beam onto an information surface of an optical disc through a focusing lens which is selected among a plurality of focusing lenses which are held by a movable part, as one corresponding to the thickness of a light transmissive layer of the optical disc, comprising: a focus control means for displacing the movable part so that the focusing state of the light beam is in a predetermined state; a displacement means for displacing the movable part so that the light beam traverses tracks formed on the information surface; a transfer means for transferring the displacement means in the radial direction of the optical disc; and a displacement amount control means for detecting a displacement amount of the movable part in the radial direction of the optical disc so as to decrease the displacement amount of the movable part; wherein the acceleration of the transfer means is lowered in a state where the displacement amount control means is not operated than in the state where it is operated.

According to Claim 7 of the present invention, there is provided an integrated circuit for an optical head transfer device for transferring an optical head which projects a light beam onto an information surface of an optical disc through a focusing lens which is selected among a plurality of focusing lenses which are held by a movable part, as one corresponding to the thickness of a light transmissive layer of the optical disc, wherein the optical head transfer device includes: a focus control means for displacing the movable part so that the focusing state of the light beam is a predetermined state; a displacement means for displacing the movable part so that the light beam traverses tracks formed on the information surface; and a transfer means for transferring the displacement means in the radial direction of the optical disc; and the integrated circuit includes: an abnormality detection means for detecting abnormality of the focus control means; and a drive means for driving the transfer means, and the drive means is controlled so as to lower the acceleration of the transfer means when abnormality of the focus control means is detected by the abnormality detection means while driving the transfer means by the drive means.

According to Claim 8 of the present invention, there is provided an integrated circuit for an optical head transfer device for transferring an optical head which projects a light beam onto an information surface of an optical disc through a focusing lens which is selected among a plurality of focusing lenses which are held by a movable part, as one corresponding to the thickness of a light transmissive layer of the optical disc, wherein the optical head transfer device includes: a focus control means for displacing the movable part so that the focusing state of the light beam is a predetermined state; a displacement means for displacing the movable part so that the light beam traverses tracks formed on the information surface; a transfer means for transferring the displacement means in the radial direction of the optical disc; and a displacement amount control means for detecting a displacement amount of the movable part in the radial direction of the optical disc so as to decrease the displacement amount of the movable part; and the integrated circuit includes a drive means for driving the transfer means, and the drive means is controlled so as to drive the transfer means in the state where the displacement amount control means is operated.

According to Claim 9 of the present invention, there is provided an integrated circuit for an optical head transfer device for transferring an optical head which projects a light beam onto an information surface of an optical disc through a focusing lens which is selected among a plurality of focusing lenses which are held by a movable part, as one corresponding to the thickness of a light transmissive layer of the optical disc, wherein the optical head transfer device includes: a focus control means for displacing the movable part so that the focusing state of the light beam is in a predetermined state; a displacement means for displacing the movable part so that the light beam traverses tracks formed on the information surface; a transfer means for transferring the displacement means in the radial direction of the optical disc; and a displacement amount control means for detecting a displacement amount of the movable part in the radial direction of the optical disc to decrease the displacement amount of the movable part; and the integrated circuit includes a drive means for driving the transfer means, and the drive means is controlled so as to lower the acceleration of the transfer means in the state where the displacement amount control means is not operated than in the state where it is operated.

According to Claim 13 of the present invention, there is provided an optical head transfer device for transferring an optical head which projects a light beam onto an information surface of an optical disc through a focusing lens which is selected among a plurality of focusing lenses which are held by a movable part, as one corresponding to the thickness of a light transmissive layer of the optical disc, comprising: a focus control means for displacing the movable part so that the focusing state of the light beam is in a predetermined state; a displacement means for displacing the movable part so that the light beam traverses tracks formed on the information surface; a transfer means for transferring the displacement means in the radial direction of the optical disc; and a displacement amount control means for detecting a displacement amount of the movable part in the radial direction of the optical disc so as to decrease the displacement amount of the movable part; wherein the transfer means is driven in the state where the displacement amount of the movable part in the radial direction of the optical disc is made zero by the displacement amount control means.

According to Claim 14 of the present invention, there is provided an optical head transfer device for transferring an optical head which projects a light beam onto an information surface of an optical disc through a focusing lens which is selected among a plurality of focusing lenses which are held by a movable part, as one corresponding to the thickness of a light transmissive layer of the optical disc, comprising: a focus control means for displacing the movable part so that the focusing state of the light beam is in a predetermined state; a displacement means for displacing the movable part so that the light beam traverses tracks formed on the information surface; a transfer means for transferring the displacement means in the radial direction of the optical disc; and an abnormality detection means for detecting abnormality of the focus control means; wherein the transfer means is driven in the state where the focus control means is not operated, when abnormality of the focus control means is detected by the abnormality detection means while driving the transfer means.

According to Claim 18 of the present invention, there is provided an optical head transfer device for transferring an optical head which projects a light beam onto an information surface of an optical disc through a focusing lens which is selected among a plurality of focusing lenses which are held by a movable part, as one corresponding to the thickness of a light transmissive layer of the optical disc, comprising: a focus control means for displacing the movable part so that the focusing state of the light beam is in a predetermined state; a displacement means for displacing the movable part so that the light beam traverses tracks formed on the information surface; a transfer means for transferring the displacement means in the radial direction of the optical disc; a displacement amount control means for detecting a displacement amount of the movable part in the radial direction of the optical disc so as to decrease the displacement amount of the movable part; and a focus control state adjustment means for adjusting the control by the focus control means according to the displacement amount of the movable part in the radial direction of the optical disc; wherein the control by the focus control means is adjusted according to the displacement amount of the movable part when the transfer means is driven.

According to Claim 22 of the present invention, there is provided an integrated circuit for an optical head transfer device for transferring an optical head which projects a light beam onto an information surface of an optical disc through a focusing lens which is selected among a plurality of focusing lenses which are held by a movable part, as one corresponding to the thickness of a light transmissive layer of the optical disc, wherein the optical head transfer device includes: a focus control means for displacing the movable part so that the focusing state of the light beam is in a predetermined state; a displacement means for displacing the movable part so that the light beam traverses tracks formed on the information surface; a transfer means for transferring the displacement means in the radial direction of the optical disc; and a displacement amount control means for detecting a displacement amount of the movable part in the radial direction of the optical disc so as to decrease the displacement amount of movable part; and the integrated circuit includes a drive means for driving the transfer means, and the drive means is controlled so as to drive the transfer means in the state where the displacement amount of the movable part in the radial direction of the optical disc is made zero by the displacement amount control means.

According to Claim 23 of the present invention, there is provided an integrated circuit for an optical head transfer device for transferring an optical head which projects a light beam onto an information surface of an optical disc through a focusing lens which is selected among a plurality of focusing lenses which are held by a movable part, as one corresponding to the thickness of a light transmissive layer of the optical disc, wherein the optical head transfer device includes: a focus control means for displacing the movable part so that the focusing state of the light beam is in a predetermined state; a displacement means for displacing the movable part so that the light beam traverses tracks formed on the information surface; a transfer means for transferring the displacement means in the radial direction of the optical disc; and an abnormality detection means for detecting abnormality of the focus control means; and the integrated circuit includes a drive means for driving the transfer means; and the drive means is controlled so as to drive the transfer means with the focus control means being put in the non-operating state, when abnormality of the focus control means is detected by the abnormality detection means while driving the transfer means.

According to Claim 24 of the present invention, there is provided an integrated circuit for an optical head transfer device for transferring an optical head which projects a light beam onto an information surface of an optical disc through a focusing lens which is selected among a plurality of focusing lenses which are held by a movable part, as one corresponding to the thickness of a light transmissive layer of the optical disc, wherein the optical head transfer device includes: a focus control means for displacing the movable part so that the focusing state of the light beam is in a predetermined state; a displacement means for displacing the movable part so that the light beam traverses tracks formed on the information surface; a transfer means for transferring the displacement means in the radial direction of the optical disc; and a displacement amount control means for detecting a displacement amount of the movable part in the radial direction of the optical disc so as to decrease the displacement amount of the movable part; and the integrated circuit includes: a focus control state adjustment means for adjusting the control by the focus control means according to the displacement amount of the movable part in the radial direction of the optical disc; and a drive means for driving the transfer means; and the control by the focus control means is adjusted according to the displacement amount of the movable part when the transfer means is driven.

According to Claim 30 of the present invention, there is provided a focusing lens driving device provided on an optical head which projects a light beam onto an information surface of an optical disc through a focusing lens which is selected among a plurality of focusing lenses which are held by a movable part, as one corresponding to the thickness of a light transmissive layer of the optical disc, comprising: the movable part; and a plurality of bar-shaped elastic support members which movably support the movable part in a light axis direction of the focusing lens and in a direction perpendicular to the light axis direction, each of the bar-shaped elastic support members extending along a tangential direction of the optical disc, with one end being fixed to a fixed part and the other end being connected to the movable part, and having a cross section of ellipse with its longitudinal axis in the light axis direction.

According to Claim 33 of the present invention, there is provided a focusing lens driving device provided on an optical head which projects a light beam onto an information surface of an optical disc through a focusing lens which is selected among a plurality of focusing lenses which are held by a movable part, as one corresponding to the thickness of a light transmissive layer of the optical disc, comprising: the movable part; bar-shaped elastic support members for movably supporting the movable part in a light axis direction of the focusing lens and in a direction perpendicular to the light axis direction, each of the bar-shaped elastic support member extending along a tangential direction of the optical disc, with one end being fixed to a fixed part and the other end being connected to the movable part; and a focus driving means for driving the movable part in the light axis direction, which comprises a plurality of focusing coils that are attached to both side surfaces of the movable part in the tangential direction, and a plurality of magnets that are fixed to the fixed part at a position opposed to the plural focusing coils; wherein the width of the magnet in the direction perpendicular to the light axis direction on the other end side of the bar-shaped elastic support members is larger than the width of the magnet in the direction perpendicular to the light axis on the fixed part side to which the bar-shaped elastic support members are connected.

According to Claim 35 of the present invention, there is provided a focusing lens driving device provided on an optical head which projects a light beam onto an information surface of an optical disc through a focusing lens which is selected among a plurality of focusing lenses which are held by a movable part, as one corresponding to the thickness of a light transmissive layer of the optical disc, comprising: the movable part; bar-shaped elastic support members for movably supporting the movable part in a light axis direction of the focusing lens and in a direction perpendicular to the light axis direction, each of the bar-shaped elastic support member extending along a tangential direction of the optical disc, with one end being fixed to a fixed part and the other end being connected to the movable part; and a focus driving means for driving the movable part in the light axis direction, which comprises a plurality of focusing coils that are attached to both side surfaces of the movable part in the tangential direction, and a plurality of magnets that are fixed to the fixed part at a position opposed to the plural focusing coils; wherein a magnetic circuit is constituted such that an electromagnetic force is increased when the focusing coils are located at the outer circumference of the magnet due to that the movable part is displaced in the direction perpendicular to the light axis.

According to Claim 39 of the present invention, there is provided an integrated circuit for a focusing lens driving device provided on an optical head which projects a light beam onto an information surface of an optical disc through a focusing lens which is selected among a plurality of focusing lenses which are held by a movable part, as one corresponding to the thickness of a light transmissive layer of the optical disc; wherein the focusing lens driving device includes the movable part; bar-shaped elastic support members for movably supporting the movable part in a light axis direction of the focusing lens and in a direction perpendicular to the light axis direction, each of the bar-shaped elastic support member extending along a tangential direction of the optical disc, with one end being fixed to a fixed part and the other end being connected to the movable part; a focus driving means for driving the movable part in the light axis direction, which comprises a plurality of focusing coils that are attached to both side surfaces of the movable part in the tangential direction, and a plurality of magnets that are fixed to the fixed part at a position opposed to the plural focusing coils, and the plural focusing coils comprise first focusing coils and second focusing coils which are divided along the tangential direction; and the integrated circuit adjusts the respective current values supplied to the first focusing coils and the second focusing coils according to the displacement amount of the movable part in the direction perpendicular to the light axis, thereby to drive the movable part in a tilting direction that is a rotation direction around the tangential direction.

### EFFECTS OF THE INVENTION

According to the present invention, since the optical head transfer device is constructed so as to lower the acceleration of the transfer means when abnormality of the focus control means is detected by the abnormality detection means while driving the transfer means and thus the optical head is transferred with the acceleration of the transfer means being lowered, the optical head can be reliably transferred with the displacement amount of the movable part being decreased.

Further, according to the present invention, since the optical head transfer device is constituted so as to drive the transfer means in the state where the displacement amount control means is operated and thus the displacement amount of the movable part is decreased, the optical head can be transferred in short time.

Further, according to the present invention, since the optical head transfer device is constructed so as to lower the acceleration of the transfer means in the state where the displacement amount control means is not operated than in the state where it is operated and thus the optical head is transferred with the acceleration of the transfer means being lowered in the state where the displacement amount control means is not operated, the optical head can be reliably transferred with the displacement amount of the movable part being decreased.

Further, according to the present invention, since the optical head transfer device is constructed so as to drive the transfer means in the state where the displacement amount of the movable part in the radial direction of the optical disc is made zero by the displacement amount control means and thus the initial position of the movable part can be located at the center position in the movable range, the movable part can be prevented from being displaced to collide with the fixed part, and thereby the optical head can be reliably transferred.

Further, according to the present invention, since the optical head transfer device is constructed so as to drive the transfer means with the focus control means being put in the non-operating state when abnormality of the focus control means is detected by the abnormality detection means while driving the transfer means, the optical head can be reliably transferred.

Further, according to the present invention, since the optical head transfer device is constructed so as to adjust the control by the focus control means according to the displacement amount of the movable part when the transfer means is driven and thus the focus control system is stabilized, the focus control system is prevented from becoming abnormal even when the movable part is displaced and collides with the fixed part, and thereby the optical head can be reliably transferred.

Further, according to the present invention, since the bar-shaped elastic support member is constructed extending along the tangential direction of the optical disc with one end being connected to a fixed part and the other end being connected to the movable part, and having a cross section of ellipse with its longitudinal axis in light axis direction, and thus tilting of the movable part which occurs when transferring the optical head can be reduced, the movable part can be prevented from being displaced to collide with the fixed part, and thereby the optical head can be reliably transferred.

Further, according to the present invention, since the width of the magnet in the direction perpendicular to the light axis on the other end side of the bar-shaped elastic support member is made larger than the width of the magnet on the fixed part side to which the bar-shaped elastic support member is connected and thus tilting of the movable part which occurs while transferring the optical head can be reduced, the movable part can be prevented from being displaced to collide with the fixed part, and thereby the optical head can be reliably transferred.

Further, according to the present invention, since the magnetic circuit is constructed so as to increase the electromagnetic force when the focusing coil is located at a position in the outer circumference of the magnet due to that the movable part is displaced in the direction perpendicular to the light axis and thus tilting of the movable part which occurs while transferring the optical head can be reduced, the movable part can be prevented from being displaced to collide with the fixed part, and thereby the optical head can be reliably transferred.

Further, according to the present invention, since the optical head transfer device is constructed such that the movable part is driven in the tilting direction which is the rotation direction around the tangential direction by adjusting the current values supplied to the first focusing coils and the second focusing coils in accordance with the displacement amount of the movable part in the direction perpendicular to the light axis and thereby tilting of the movable part which occurs while transferring the optical head can be reduced, the movable part can be prevented from being displaced to collide with the fixed part, and thus the optical head can be reliably transferred.

### BRIEF DESCRIPTION OF THE DRAWINGS

FIG. 1 is a diagram illustrating the construction of an optical head transfer device according to a first embodiment of the present invention.

FIG. 2 is a diagram illustrating a movable part of a lens actuator.

FIG. 3(a) is a diagram illustrating a first speed profile possessed by a transfer motor control circuit, FIG. 3(b) is a diagram illustrating the acceleration of the first speed profile, FIG. 3(c) is a diagram illustrating a second speed profile, and FIG. 3(d) is a diagram illustrating the acceleration of the second speed profile.

FIG. 4 is a flowchart illustrating the operation of the transfer motor control circuit of the optical head transfer device according to the first embodiment.

FIG. 5(a) is a diagram illustrating the construction of an optical head transfer device according to a second embodiment of the present invention.

FIG. 5(b) is a diagram illustrating the construction of another example of the optical head transfer device according to the second embodiment.

FIG. 6 is a diagram illustrating a lens shift signal.

FIG. 7 is a flowchart illustrating the operation of the transfer motor control circuit of the optical head transfer device according to the second embodiment.

FIG. 8 is a flowchart illustrating the operation of the transfer motor control circuit of the optical head transfer device according to the second embodiment.

FIG. 9 is a diagram illustrating the construction of an optical head transfer device according to a third embodiment of the present invention.

FIG. 10 is a diagram illustrating a focus error signal.

FIG. 11 is a diagram illustrating an amplitude and an offset of a focus error signal against a lens shift.

FIG. 12 is a diagram showing a gain table and an offset table.

FIG. 13 is a diagram illustrating the construction of an optical head transfer device according to a fourth embodiment of the present invention.

FIG. 14 is a configuration diagram from top view of an overhead view of a lens actuator in the optical head transfer device according to the fourth embodiment.

FIG. 15 is a configuration diagram from lateral view of the lens actuator in the optical head transfer device according to the fourth embodiment.

FIG. 16 is a diagram illustrating tilting of a movable part of the lens actuator of the optical head transfer device according to the fourth embodiment.

FIG. 17(a) is a diagram for explaining tilting of the movable part with respect to a lens shift signal in the optical head transfer device according to the fourth embodiment, and FIG. 17(b) is a diagram for explaining a tilt offset setting circuit.

FIG. 18 is a configuration diagram from top view of a lens actuator in an optical head transfer device according to a fifth embodiment of the present invention.

FIG. 19 is a configuration diagram from lateral view of the lens actuator in the optical head transfer device according to the fifth embodiment of the present invention.

FIG. 20 is a configuration diagram from top view of the lens actuator in the optical head transfer device according to the fifth embodiment of the present invention.

FIG. 21 is a diagram illustrating the relationship between an optical disc and focusing lenses in the conventional device.

FIG. 22 is a diagram illustrating the relationship between an optical disc and focusing lenses in the conventional device.

FIG. 23 is a diagram illustrating an optical head in the conventional device.

FIG. 24 is a diagram illustrating an optical element of the optical head in the conventional device.

### DESCRIPTION OF REFERENCE NUMERALS

2 . . . movable part
3 . . . optical disc
4 . . . disc motor
5 . . . light source
6 . . . coupling lens
7 . . . polarization beam splitter
8 . . . ¼ wavelength plate
9 . . . optical head
10 . . . focusing lens
11 . . . lens actuator
12 . . . photodetector
13 . . . transfer motor
14 . . . focusing coil
16 . . . focus error generation circuit
17 . . . A/D converter
18 . . . phase compensation circuit
19 . . . D/A converter
20 . . . power amplification circuit
22 . . . focusing lens
24 . . . transfer motor control circuit
25 . . . D/A converter
26 . . . power amplification circuit
27 . . . A/D converter
50 . . . brightness level detection circuit
52 . . . A/D converter
53 . . . subtraction circuit
54 . . . phase compensation circuit
55 . . . D/A converter
56 . . . power amplification circuit
57 . . . brightness level detection circuit
58 . . . A/D converter
59 . . . transfer motor control circuit
60 . . . tracking coil
70 . . . subtraction circuit
71 multiplication circuit
72 . . . offset table
73 . . . gain table
152 . . . addition circuit
153 . . . subtraction circuit
154 . . . tilt offset setting circuit
155 . . . lens actuator
80 . . . yoke
81 . . . first magnet
82 . . . first focusing coil
83 . . . second focusing coil
84 . . . wire
87 . . . terminal plate
88 . . . second magnet
89 . . . yoke
90 . . . fixed part
250 . . . first magnet
251 . . . yoke
252 . . . wire
260 . . . first magnet
261 . . . second magnet
100 . . . optical disc/optical head block
200 . . . focus control block
300 . . . abnormality detection block
400 . . . transfer system driving block
500 . . . displacement amount control block
600 . . . focus control state adjustment block
800 . . . tilt offset adjustment block
1000,2000a,2000b,3000,4000 . . . optical head transfer device

### BEST MODE TO EXECUTE THE INVENTION

Hereinafter, optical head transfer devices and integrated circuits of the optical head transfer devices according to the present invention will be described with reference to the attached drawings.

### Embodiment 1

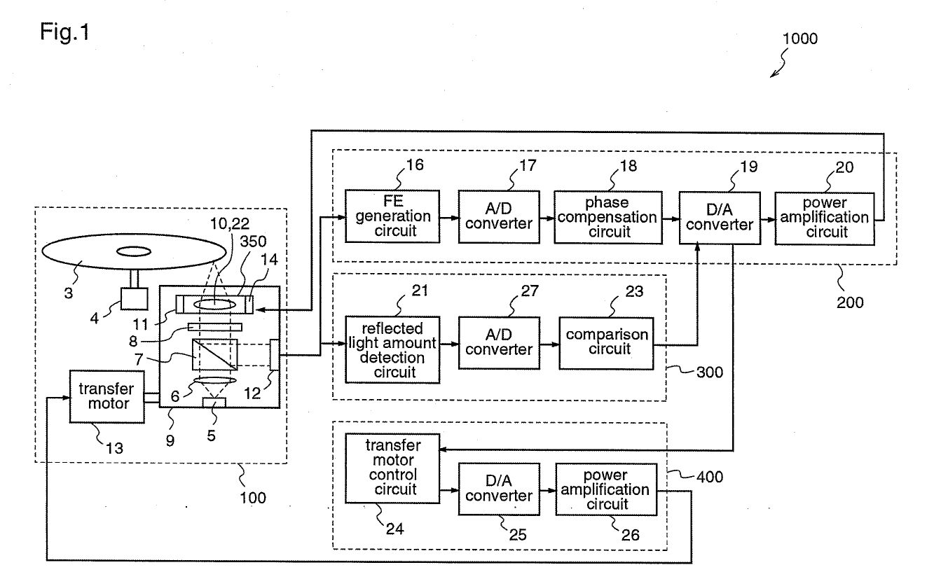

FIG. 1 is a constitutional diagram of an optical head transfer device 1000 according to a first embodiment of the present invention.

In the optical head transfer device 1000 of this first embodiment, the constituents thereof can be separated into four blocks. That is, there are an optical disc/optical head block 100 for projecting a light beam onto an optical disc and receiving light from the optical disc, a focus control block 200 for realizing focus control, a focus abnormality detection block 300 for detecting abnormality of the focus control system, and a transfer system driving block 400 for controlling a transfer motor which transfers the optical head.

Hereinafter, the constructions and operations of the respective blocks 100, 200, 300, and 400 will be described.

Optical Disc/Optical Head Block 100

The optical disc/optical head block 100 is constituted by an optical disc 3 as an information recording medium, a disc motor 4 such as a spindle motor for rotating the optical disc 3, an optical head 9 for projecting a light beam onto the optical disc 3, and a transfer motor 13 as an example of a transfer means for moving the optical head 9. On the optical disc 3, plural tracks are formed concentrically or spirally with respect to the center of the optical disc. The optical head 9 comprises a light source 5 such as a semiconductor laser, a coupling lens 6 to which a light beam emitted from the light source 5 is successively applied, a deflection beam splitter 7, a ¼ wavelength plate 8, first and second focusing lenses 10 and 22, a lens actuator 11, and a photodetector 12 to which the light beam from the optical disc 3 is applied. The optical head 9 does not necessarily require the above-described constituents, but the constitution thereof is illustrated as an example.

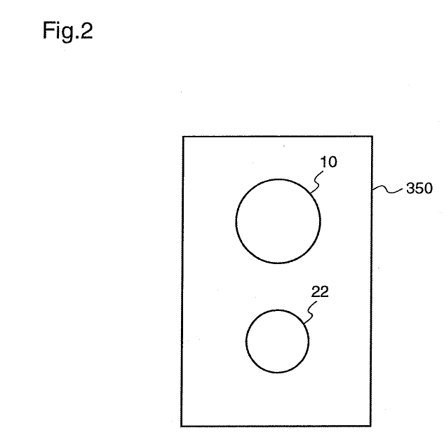

The lens actuator 11 is constituted by a lens holder 350 having a focusing coil 14, and a fixed part (not shown) having a permanent magnet. As shown in FIG. 2, the two focusing lenses 10 and 22 are attached to the lend holder 350 of the lens actuator 11.

FIG. 2 shows the optical head viewed from above in FIG. 1. The first focusing lens 10 is a focusing lens used when a first optical disc is loaded. The second focusing lens 22 is a focusing lens used when a second optical disc is loaded.

The first and second focusing lenses 10 and 22, the lens holder 350, the focusing coil 14, and a tracking coil constitute a movable part 2.

Returning to FIG. 1, the light source 5, the coupling lens 6, the deflection beam splitter 7, the ¼ wavelength plate 8, the focusing lens 10, and the photodetector 12 constitute an optical system which is used when the first optical disc is loaded, and a similar optical system which is used when the second optical disc is loaded is separately provided (not shown).

Next, the optical system for the first optical disc will be described.

The photodetector 12 has a plurality of divided light-receiving regions, and receives the reflected light from the optical disc.

The optical disc/head block 100 thus constituted will be operated as follows.

The optical disc 3 is rotated by the disc motor 4 at a predetermined rotation number (rotation speed). A light beam emitted from the light source 5 is converted into a parallel beam by the coupling lens 6, passes through the deflection beam splitter 7 and the ¼ wavelength plate 8 in this order, and is focused on the optical disc 3 by the first focusing lens 10. The first focusing lens 10 constitutes a focusing means for focusing the light beam on the optical disc 3.

The reflected light that is obtained by the light beam incident on the optical disc 3 being reflected is transmitted through the first focusing lens 10 and the ¼ wavelength plate 8 in this order, and applied to the photodetector 12 after being reflected by the deflection beam splitter 7. The respective light receiving regions of the photodetector 12 convert the incident light into electric signals, and output the electric signals to the focus control block 200 and to the focus abnormality detection block 300.

The irradiation position of the light beam to the optical disc 3 can be adjusted by the transfer motor 13 and the lens actuator 11. The transfer motor 13 moves the whole optical head 9 in the radial direction of the optical disc 3. The lens actuator 11 moves the light beam in the radial direction of the optical disc 3, i.e., in the direction that traverses the track, by changing the relative position of the focusing lens to the permanent magnet of the fixed part with utilizing an electromagnetic force which arises depending on the current flowing through the tracking coil (not shown) in the movable part 2.

Hereinafter, a displacement of the movable part 2 in the radial direction of the optical disc 3 is referred to as “lens shift”. Further, the radial direction of the optical disc 3 is referred to as “tracking direction”.

The transfer motor 13 is used when transferring the whole optical head 9 in the radial direction of the optical disc, and the lens actuator 11 is used for moving the light beam for each one track. While the lens actuator 11 constitutes a moving means for moving the light beam to a predetermined track by moving the focusing lens 10 as an example of a focusing means for focusing the light beam, this moving means is not restricted to the lens actuator 11.

The lens actuator 11 moves the focus of the light beam in the focusing direction (vertical direction in the figure) by changing the relative position of the focusing lens to the permanent magnet of the fixed part with utilizing an electromagnetic force which arises according the current flowing through the focusing coil 14 in the movable part 2.

Focus Control Block 200

Included in circuits for focus control are a focus error generation circuit 16 (referred to as “FE generation circuit”), an A/D converter 17, a phase compensation circuit 18, a D/A converter 19, and a power amplification circuit 20.

A focus error signal as an output of the FE generation circuit 16 is converted from an analog signal to a digital signal by the A/D converter 17 to be inputted to the phase compensation circuit 18. The control stability of the focus control system is ensured by the phase compensation circuit 18, although the detail thereof is omitted. The output signal of the phase compensation circuit 18 is input to the D/A converter 19. The D/A converter 19 converts the digital signal into an analog signal. The output of the D/A converter 19 is forwarded to the focusing coil 14 in the lens actuator 11 through the power amplification circuit 20.

As already described, the lens actuator 11 is controlled so as to move the first focusing lens 10 in the focusing direction such that the focusing state of the light beam on the information surface of the optical disc is in a predetermined state. Besides, the focus control system is put in the non-operating state by halting the operation of the D/A converter 10. When putting the focus control system in the operating state, the first focusing lens 10 is gently moved toward the optical disc 3, and when the focus error signal enters the detectable range, the D/A converter 19 is operated.

Abnormality Detection Block 300

Included in the abnormality detection block 300 are a reflection light amount detection circuit 21, an A/D converter 27, and a comparator 23. The abnormality detection block 300 constitutes an abnormality detection means which detects abnormality of the focus control system (focus control block 200) on the basis of the reflected light that is obtained by the light beam incident on the optical disc 3 being reflected.

The reflection light amount detection circuit 21 adds the output signals from the photodetector 12 and detects the reflection light amount from the optical disc 3. The output of the reflection light amount detection circuit 21 is forwarded to the comparison circuit 23 through the A/D converter 27. The comparator circuit 23 halts the operation of the A/D converter 19 as recognizing the focus control system is in the abnormal state when the reflection light amount level is lower than a predetermined level. Thus, the focus control system is put in the non-operating state.

Next, the abnormal state of the focus control system will be described. If the information surface of the optical disc 3 and the focus of the light beam are significantly deviated due to such as an impact being applied to the optical head transfer device, the reflection light amount of the reflected light from the optical disc 3 which is incident on the photodetector 12 is reduced. Therefore, the abnormal state of the focus control system can be detected by the reflection light amount detection circuit 21.

Further, since the focus in such state is out of the focus error signal detectable range and the focus error cannot be detected, the focus control system is not in the normal state. When it has come into such state, the focus control system is once put in the non-operating state as described above and the first focusing lens 10 is gently moved closer to the optical disc 3, and when the focus error signal enters the detectable range, the D/A converter 19 is operated.

Transfer System Driving Block 400

Included in the transfer system driving block 400 are a transfer motor control circuit 24, a D/A converter 25, and a power amplification circuit 26. The transfer system driving block 400 constitutes a transfer system driving means which drives the transfer motor 13 as a transfer means for transferring the optical head 9 in the radial direction of the optical disc 3.

The transfer motor control circuit 24 controls the output level to the transfer motor 13 so that the speed of the optical head 9 which is transferred by the transfer motor 13 in the radial direction of the optical disc 3 has a predetermined speed profile. As for the speed profile, two types of speed profiles are provided.

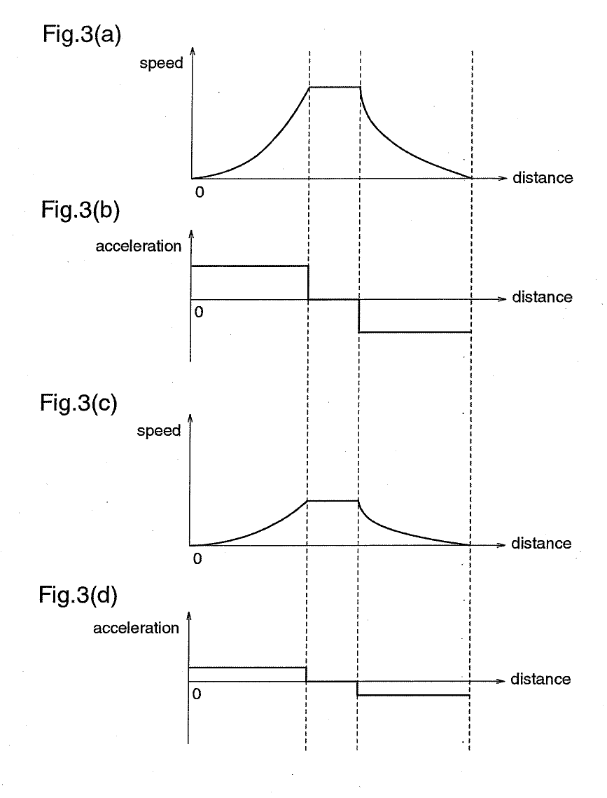

FIG. 3 shows such speed profiles. FIG. 3(a) shows the first speed profile, and FIG. 3(b) shows an acceleration in the first speed profile. FIG. 3(c) shows the second speed profile, and FIG. 3(d) shows an acceleration in the second speed profile. The acceleration in FIG. 3(d) is smaller than the acceleration in FIG. 3(b).

When the acceleration is large, the movable part 2 is significantly displaced in the radial direction of the optical disc 3 due to rolling or vibration at the inherent resonance frequency. However, when the optical head is transferred in a predetermined distance, the transfer can be completed in a short time.

Besides, even when the transfer is carried out at the same acceleration, the displacement amount of the movable part 2 varies depending on the variations in the characteristics of the individual lens actuators 11. Therefore, when manufacturing a plurality of optical head transfer devices, even when the optical head is transferred with a large acceleration, the displacement amount might be small. If the acceleration is equally lowered in such case, the transfer time would be increased in all devices.

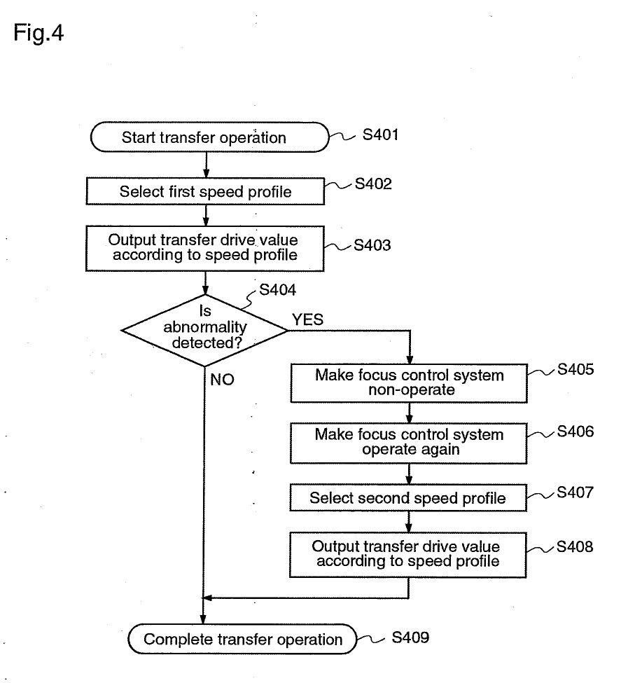

So, as shown in a flowchart of FIG. 4, it is constructed such that the initial transfer is carried out with the first speed profile shown in FIG. 3(a), and upon detection of abnormality of the focus control system, the transfer is again carried out with the second speed profile having the lower acceleration of FIG. 3(c). Thus, it is possible to carry out the transfer reliably without increasing the transfer time in all devices. Hereinafter, the flowchart of FIG. 4 will be described in detail.

FIG. 4 is a flowchart illustrating the operation of the transfer motor control circuit in the optical head transfer device according to the first embodiment.

With reference to FIG. 4, the transfer operation is started (step S401), the first profile is selected by the transfer motor control circuit 24 in the transfer system driving block 400 (step S402), and the transfer motor control circuit 24 outputs a transfer drive value to the transfer motor 13 in the optical disc/optical head block 100 through the power amplification circuit 26 in accordance with the first speed profile (step S403).

Next, it is detected whether there is abnormality of the focus control system or not by the comparison circuit 23 in the focus abnormality detection block 300 using the reflection light amount detected by the reflection light amount detection circuit 21 (step S404). When abnormality of the focus control system is detected (“Yes” in step S404), a D/A converter operation instruction signal is outputted from the comparison circuit 23 to the D/A converter 19 to make the focus control system temporary non-operating (step S405). At this time, a focus control system state notification signal is outputted from the D/A converter 19 to the transfer motor control circuit 24 to temporary halt the transfer operation.

Next, a D/A converter operation instruction signal is outputted from the comparison circuit 23 to the D/A converter 19 to make the focus control system operate again (step S406). At this time, a focus control system state notification signal is outputted from the D/A converter 19 to the transfer motor control circuit 24. The transfer motor control circuit 24 selects the second speed profile (step S407), and the transfer motor control circuit 24 outputs a transfer drive value to the transfer motor 13 through the power amplification circuit 26 according to the second speed profile (step S408), and thereby the transfer operation is performed, and thereafter, the transfer operation is completed (step S409).

When abnormality of the focus control system is not detected (“No” in step S404), the transfer drive value is outputted as it is according to the first speed profile to perform the transfer operation, and thereafter, the transfer operation is completed (step S409).

While in this first embodiment the optical head is transferred with the first speed profile and when abnormality of the focus control system is detected, it is again transferred with the second speed profile of the lower acceleration, the optical head may be transferred with the focus control system being put in the non-operating state when abnormality of the focus control system is detected. In this case, since the focus control system is in the non-operating state, the lens actuator 11 may be driven so as to move the movable part 2 away from the optical disc 3 by using the power amplification circuit 20, thereby to prevent the first focusing lens 10 in the movable part 2 from colliding with the optical disc 3.

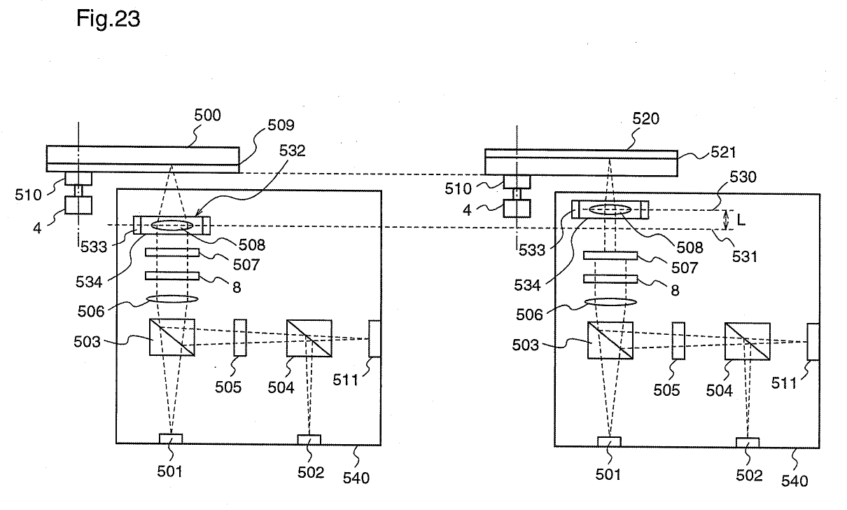

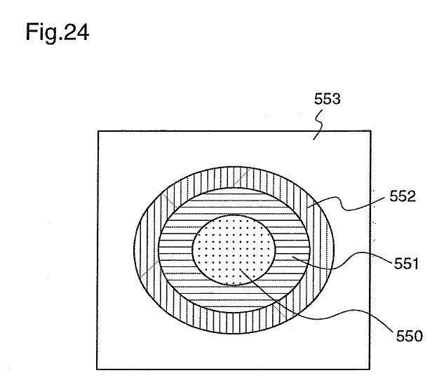

Further, while in this first embodiment the case of transferring the optical head 9 having a plurality of focusing lenses is described, the first embodiment can be applied to the case of using the optical head 540 having one focusing lens shown in FIG. 23 which is described with respect to the background art, and the same effects as described above can be obtained. In this case, the output signal of the power amplification circuit 20 shown in FIG. 1 is forwarded to the focusing coil 533 shown in FIG. 23. Further, the output signal of the photodetector 511 shown in FIG. 23 is forwarded to the FE generation circuit 16 and the reflection light amount detection circuit 21 shown in FIG. 1.

Further, an integrated circuit for the optical head transfer device of this first embodiment includes an abnormality detection means for detecting abnormality of the focus control block 200 in the optical head transfer device, and a driving means for driving the transfer motor 13, and the driving means is controlled so as to lower the acceleration of the transfer motor 13 when abnormality of the focus control block 200 is detected by the abnormality detection means while the driving means drives the transfer motor 13. Further, another example of an integrated circuit for the optical head transfer device of this first embodiment includes a driving means for driving the transfer motor 13, and the driving means is controlled so as to drive the transfer motor with the focus control block 200 being put in the non-operating state when abnormality of the focus control block 200 is detected by the focus abnormality detection block 300 while driving the transfer motor 13.

According to the optical head transfer device of this first embodiment, there are provided the focus control block 200 for displacing the movable part 2 so that the focusing state of the light beam is in a predetermined state, the lens actuator 11 for displacing the movable part 2 so that the light beam traverses the tracks formed on the information surface, the transfer motor 13 for transferring the lens actuator 11 in the radial direction of the optical disc, and the focus abnormality detection block 200 for detecting abnormality of the focus control block 200, and the acceleration of the transfer motor 13 is lowered when abnormality of the focus control block 200 is detected by the focus abnormality detection block 300 while driving the transfer motor 13. Therefore, in such case, the optical head is transferred with the acceleration of the transfer motor 13 being lowered, and thereby the optical head can be reliably transferred to an exact target position with the displacement amount of the movable part 2 being decreased.

### Embodiment 2

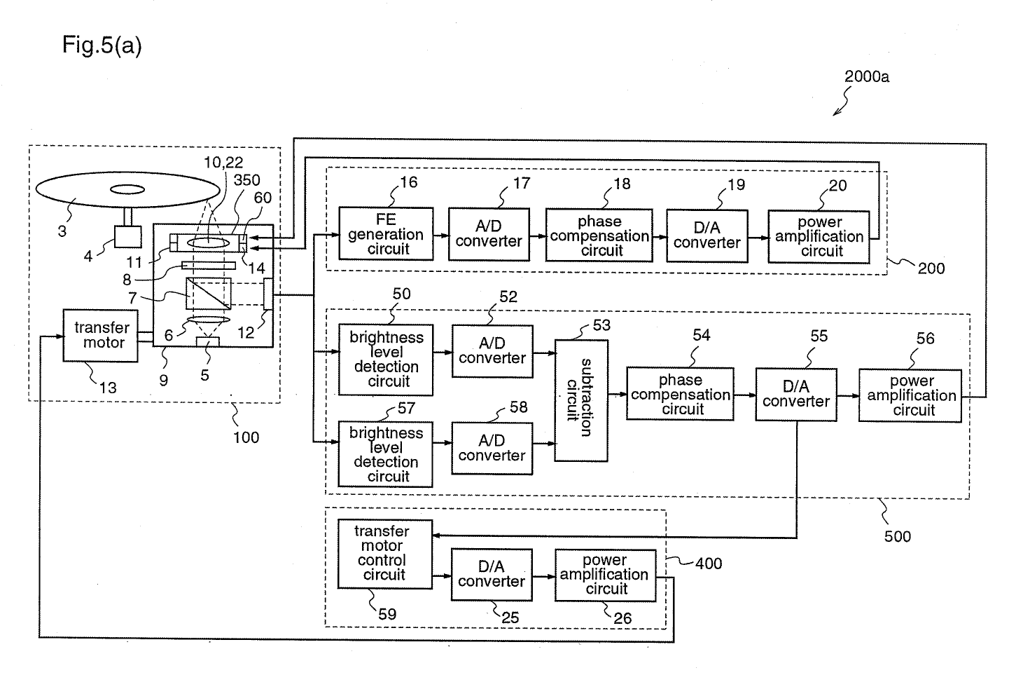

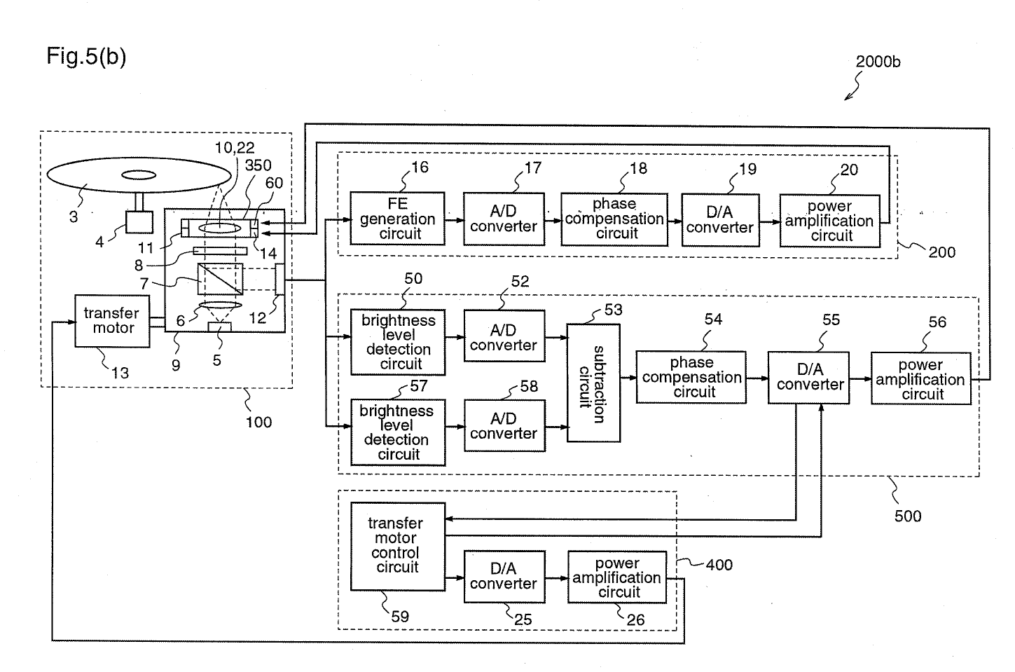

Next, an optical head transfer device 2000a according to a second embodiment of the present invention will be described with reference to FIG. 5(a).

In this second embodiment, there is provided a displacement amount control system which detects a displacement amount of the movable part 2 in the radial direction of the optical disc 3 to decrease the displacement amount of the movable part 2, and the acceleration of the transfer system is increased when the displacement amount control system is in the operating state than when it is in the non-operating state. In order to achieve this, a displacement amount control block 500 is provided. Further, the function of the transfer motor control circuit 59 is partially different from that of the first embodiment. In FIG. 5(a), other constituents are identical to those shown in FIG. 1.

Hereinafter, the displacement amount control block 500 will be described.

Included in the displacement amount control block 500 for controlling the displacement amount are brightness level detection circuits 50 and 57, A/D converters 52 and 58, a subtraction circuit 53, a phase compensation circuit 54, a D/A converter 55, and a power amplification circuit 56.

Two light reception signals which are obtained by dividing the light reception signal in the track direction on the light receiving surface of the photodetector 12 are forwarded to the brightness level detection circuits 50 and 57, respectively.

A signal which is obtained by performing subtraction on the two light reception signals obtained by dividing the light reception signal in the track direction on the light receiving surface of the photodetector 12 becomes a tracking error signal obtained by a push-pull method.

The brightness level detection circuits 50 and 57 detect the higher levels (the levels having the larger received light amount) among the input signals, respectively, and output the same.

The outputs of the brightness level detection circuits 50 and 57 are forwarded to the subtraction circuit 53 through the A/D converters 52 and 58, respectively.

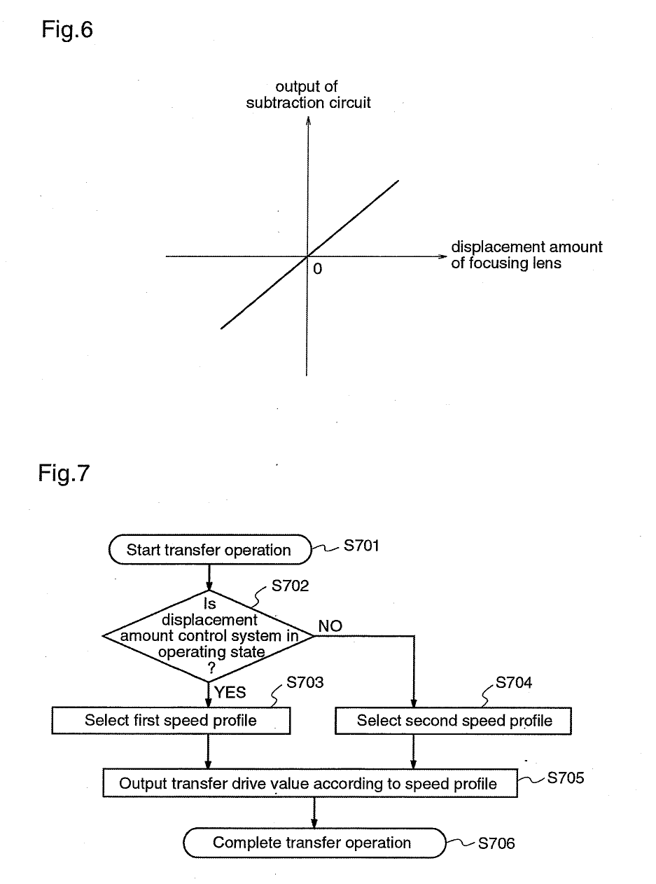

As shown in FIG. 6, the output of the subtraction circuit 53 shows a deviation from the neutral position of the first focusing lens 10, that is, the displacement amount in the radial direction of the optical disc 3. This signal is referred to as a lens shift signal.

The lens shift signal outputted from the subtraction circuit 53 is input to the phase compensation circuit 54.

The control stability of the displacement amount control system (displacement amount control block 500) is secured by the phase compensation circuit 54.

The output signal of the phase compensation circuit 54 is input to the D/A converter 55. The D/A converter 55 converts the digital signal into an analog signal. The output of the D/A converter 55 is forwarded to the tracking coil 60 of the lens actuator 11 through the power amplifier 56.

As described above, the lens actuator 11 is controlled such that the displacement of the first focusing lens 10 in the radial direction of the optical disc 3 becomes zero. The displacement amount control system enters the non-operating state by halting the operation of the D/A converter 55.

That is, when the displacement amount control system is in the operating state, the displacement amount of the focusing lens 10 can be decreased even if the optical head 9 is transferred with a large acceleration, thereby avoiding that the movable part 2 collides with the fixed part to make the focus control system abnormal.

Next, the transfer motor control circuit 59 will be described.

The transfer motor control circuit 59 controls the output level to the transfer motor 13 so that the speed of the optical head 9 which is transferred in the radial direction of the optical disc 3 by the transfer motor 13 has a predetermined speed profile. As for the speed profile, the aforementioned two types of speed profiles shown in FIG. 3 are provided.

The transfer motor control circuit 59 detects whether the displacement amount control system is in the operating state or not, according to the operation state of the D/A converter 55. As shown in the flowchart of FIG. 7, when the displacement amount control system is in the operating state, the optical head 9 is transferred with the first speed profile having the large acceleration of FIG. 3(a), and when it is in the non-operating state, the optical head 9 is transferred with the second speed profile having the small acceleration of FIG. 3(c). Thereby, it is avoided that the movable part 2 collides with the fixed part to make the focus control system abnormal. Hereinafter, the flowchart of FIG. 7 will be described in detail.

FIG. 7 is a flowchart illustrating the operation of the transfer motor control circuit of the optical head transfer device 2000a according to the second embodiment of the present invention.

In FIG. 7, the transfer operation is started (step S701), and it is detected whether the displacement amount control system is in the operating state or not according to the operation state of the D/A converter 55 in the displacement amount control block 500 (step S702). When the displacement amount control system is in the operating state (“Yes” in step S702), a displacement amount control system state notification signal is outputted from the D/A converter 55 to the transfer motor control circuit 59 to select the first profile (step S703). When the displacement amount control system is in the non-operating state (“No” in step S702), a displacement amount control system state notification signal is outputted from the D/A converter 55 to the transfer motor control circuit 59 to select the second profile (step S704). The transfer motor control circuit 59 outputs a transfer drive value according to the first or second profile to the transfer motor 13 through the power amplification circuit 26 (step S705), and thereby the transfer operation is carried out, and thereafter, the transfer operation is completed (step S706).

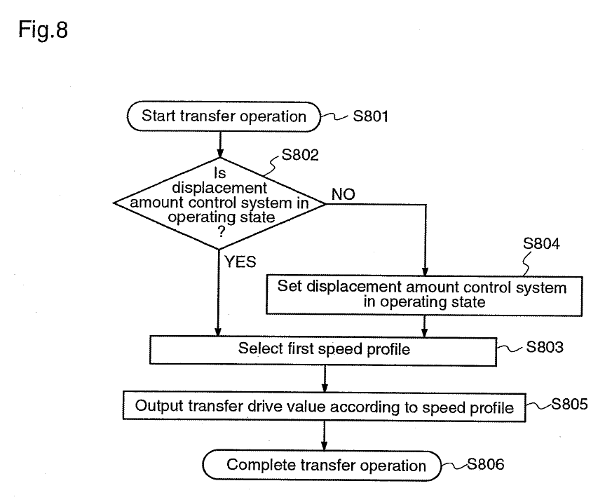

In the optical head transfer device 2000a of this second embodiment, the speed profile is changed according to whether the displacement amount control system is in the operating state or not. However, for example, in the optical head transfer device 200b shown in FIG. 5(b), the displacement amount control system may be previously put in the operating state when transferring the optical head with the first speed profile of the larger acceleration as shown in the flowchart of FIG. 8. The optical head transfer device 2000b is constructed such that a displacement amount control system notification signal is outputted from the D/A converter 55 to the transfer motor control circuit 59, and an operation state instruction signal is outputted from the transfer motor control circuit 59 to the D/A converter 55. Since other constituents are identical to those shown in FIG. 5(a), detailed description thereof will be omitted. Hereinafter, the flowchart of FIG. 8 will be described in detail.

FIG. 8 is a flowchart illustrating the operation of the transfer motor control circuit in the optical head transfer device 2000b of the second embodiment of the present invention.

In FIG. 8, the transfer operation is started (step S801), and it is detected whether the displacement amount control system is in the operating state or not according to the operation state of the D/A converter 55 in the displacement amount control block 500 (step S802). When the displacement amount control system is in the operating state (“Yes” in step S802), a displacement amount control system state notification signal is outputted from the D/A converter 55 to the transfer motor control circuit 59 to select the first speed profile (step S803). The transfer motor control circuit 59 outputs a transfer drive value according to the first speed profile to the transfer motor 13 through the power amplification circuit 26 (step S805), and thereby the transfer operation is carried out, and thereafter, the transfer operation is completed (step S806). When the displacement amount control system is in the non-operating state (“No” in step S802), a displacement amount control system state notification signal is outputted from the D/A converter 55 to the transfer motor control circuit 59, and the transfer motor control circuit 59 outputs an operation state instruction signal to the D/A converter 55, thereby putting the displacement amount control system in the operating state (step S804). Then, the first speed profile is selected (step S803), and the transfer motor control circuit 59 outputs a transfer drive value according to the first speed profile to the transfer motor 13 through the power amplification circuit 26 (step S805), and thereafter, the transfer operation is completed (step S806).

While in this second embodiment the displacement amount of the first focusing lens 10 is detected from a difference in the brightness levels of the reflection light amounts from the optical disc 3, the present invention is not restricted to this method.

For example, it may be detected based on a signal obtained by adding a main push-pull signal and a sub-push-pull signal in a differential push-pull method.

Further, while in this second embodiment the speed profile is changed according to whether the displacement amount control system is in the operating state or not, the displacement amount control system may be operated before performing transfer, and transfer of the optical head may be carried out in the state where the output signal level of the power amplification circuit 56 is held after the control system is stabilized. By operating the displacement amount control system before performing transfer and holding the output signal level of the power amplification circuit 56 after the control system is stabilized, it is possible to improve the state where one side of the movable range is narrowed due to the positional deviation of the optical part 2 in the tracking direction, which has occurred while manufacturing the lens actuator 11, or the self-weight sag of the movable part 2 in the tracking direction which is caused by the installation direction of the optical disc device. Accordingly, when the vibration of the movable part being transferred is small, the movable part 2 can be prevented from colliding with the fixed part. Since the operations of the blocks such as the phase compensation circuit 54 are halted during transfer, the power consumption of the device can be reduced.

Further, while in this second embodiment the case of transferring the optical head 9 having a plurality of focusing lenses is described, this second embodiment may be applied to the case of using the optical head 540 having one focusing lens shown in FIG. 23 which is described for the background art, and the same effects as described above can be obtained. In this case, the output signal of the power amplification circuit 20 shown in FIG. 5 is forwarded to the focusing coil 533 in FIG. 23. The output signal of the power amplification circuit 56 shown in FIG. 5 is forwarded to the tracking coil (not shown) in FIG. 23. Further, the output signal of the photodetector 511 in FIG. 23 is forwarded to the FE generation circuit 16 and to the brightness level detection circuits 50 and 57 in FIG. 5.

Further, an integrated circuit for the optical head transfer device of this second embodiment includes a driving means for driving the transfer motor 13 of the optical head transfer device, and the driving means is controlled so as to lower the acceleration of the transfer motor 13 in the state where the displacement amount control block 500 is not operated than in the state where it is operated. Further, another example of an integrated circuit for the optical head transfer device of this second embodiment includes a driving means for driving the transfer motor 13 of the optical head transfer device, and the driving means is controlled so as to drive the transfer motor 13 in the state where the displacement amount of the movable part 2 in the radial direction of the optical disc is made zero by the displacement amount control block 500.

According to the optical head transfer device of this second embodiment, the displacement amount control block 500 which detects the displacement amount of the movable part 2 in the radial direction of the optical disc 3 to decrease the displacement amount of the movable part 2 is provided, and the acceleration of the transfer system is increased when the displacement amount control block 500 is in the operating state than when it is in the non-operating state. Therefore, the optical head is transferred with the acceleration of the transfer motor 13 being lowered when the displacement amount control block 500 is in the non-operating state, and thereby the optical head can be reliably transferred to the exact target position with the displacement amount of the movable part 2 being decreased.

### Embodiment 3

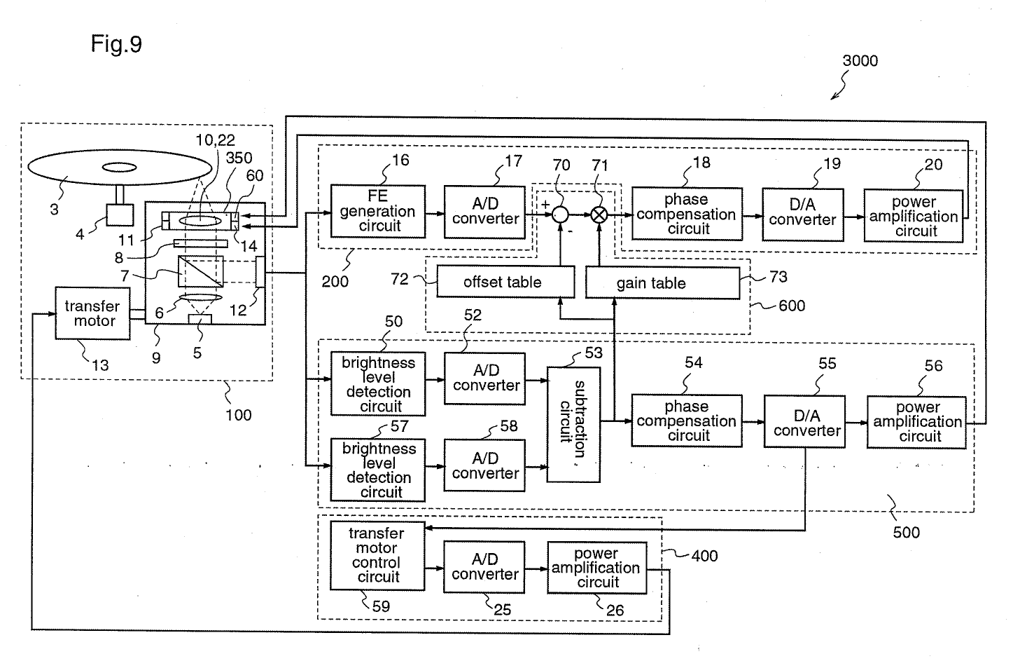

Next, an optical head transfer device 3000 according to a third embodiment of the present invention will be described with reference to FIG. 9.

In this third embodiment, the optical head transfer device 3000 is provided with a focus control state adjustment system for adjusting the control state of the focus control system according to the displacement amount of the movable part 2 in the tracking direction, thereby to correct an amplitude and an offset of a focus error signal which vary due to a displacement of the movable part 2 in the tracking direction.

In this third embodiment, a focus control state adjustment block 600 is provided to achieve this purpose. In FIG. 9, other constituents are identical to those shown in FIG. 5(a) used for the second embodiment.

The focus control state adjustment block 600 is constituted by a subtraction circuit 70, a multiplication circuit 71, an offset table 72, and a gain table 73.

The subtraction circuit 70 subtracts an output signal of the offset table 72 from an output signal of the A/D converter 17, and outputs the result.

The multiplication circuit 71 multiplies an output signal of the subtraction circuit 70 and an output signal of the gain table 73, and outputs the result.

A lens shift signal which is an output of the subtraction circuit 53 is input to the offset table 72 and the gain table 73, and the offset table 72 and the gain table 73 output signals for correcting the amplitude and the offset of the focus error signal which are varied due to lens shift, respectively.

Accordingly, the target position of the focus control system is adjusted by the offset table 72 and the subtraction circuit 70.

Further, the loop gain is adjusted by the gain table 73 and the multiplication circuit 71.

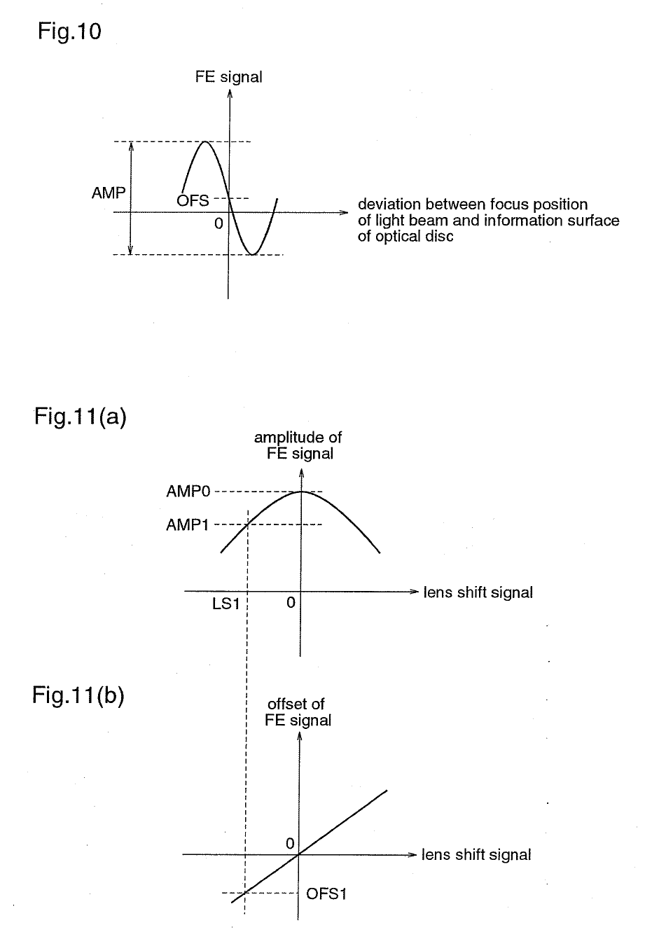

Initially, the relationship between the displacement of the movable part 2 and the focus error signal will be described with reference to FIGS. 10 and 11.

FIG. 10 is a diagram illustrating an example of the focus error signal. The ordinate of FIG. 10 shows the focus error signal which is an analog-to-digital converted signal outputted from the A/D converter 17 shown in FIG. 9.

The abscissa of FIG. 10 shows a deviation between the information surface of the optical disc 3 and the focus position of the light beam which is applied to be focused onto the optical disc 3 by the first focusing lens 10.

As shown in FIG. 10, the amplitude of the focus error signal is denoted as AMP, and the offset is denoted as OFS. As shown in FIG. 10, a focus error cannot be detected when the deviation between the focus position of the light beam and the information surface of the optical disc 3 becomes larger than a predetermined value.

FIG. 11 is a diagram illustrating an example of a relationship between the displacement of the movable part 2 in the tracking direction, i.e., the lens shift signal, and the focus error signal.

The ordinate of FIG. 11(a) shows the AMP as the amplitude of the focus error signal, while the abscissa thereof shows the lens shift signal as the output of the subtraction circuit 53.

As described above, the lens shift signal is a signal indicating the displacement amount of the movable part 2 in the radial direction of the optical disc 3, i.e., the tracking direction. As shown in FIG. 11(a), when the movement of the movable part 2 in the tracking direction becomes larger, the amplitude of the focus error signal is decreased, and thereby the focus error becomes undetectable.

The ordinate of FIG. 11(b) shows OFS which is an offset of the focus error signal. The abscissa shows the lens shift signal which is an output of the subtraction circuit 53 as shown in FIG. 11(a). As shown in FIG. 11(b), when the movement of the movable part 2 in the tracking direction becomes larger, the offset of the focus error signal is increased, resulting in defocusing.

Since a part of the light beam is kicked by the first focusing lens 10 or the like due to the lens shift of the movable part 2 as described above, the light diffuses without passing through all the lenses, and thereby the amplitude and offset of the focus error signal vary.

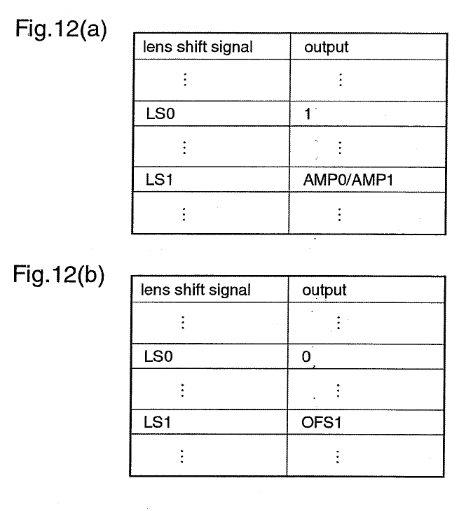

FIG. 12(a) shows an example of the gain table.

This gain table is formed based on the relationship between the lens shift signal and the focus error signal, which is shown in FIG. 11(a).

The gain table has the output values corresponding to the lens shift signals, and the output values are obtained by dividing AMP0 which is an amplitude of the focus error signal when the lens shift signal is zero, by AMPs of the respective lens shift signals.

For example, when the lens shift signal is LS1, the output value is AMP0/AMP1 which is calculated with AMP1 that is the amplitude of the focus error signal at LS1.

FIG. 12(b) shows an example of the offset table.

This offset table is formed based on the relationship between the lens shift signal and the focus error signal, which is shown in FIG. 11(b).

The offset table has the output values corresponding to the lens shift signals, and the output values are the offset values of the focus error signals at the respective lens shift signals.

For example, when the lens shift signal is LS1, the output value is OFS1 that is the offset of the focus error signal at LS1.

Since the focus error signal in the case where the lens shift of the movable part 2 is zero can be obtained by the focus control state adjustment block 600 even when the whole light beam does not pass through the lens because a part of the light beam is kicked by the focusing lens 10 or the like due to lens shift of the movable part 2 and thereby the amplitude and offset of the focus error signal are varied, the movable part 2 is not moved in the tracking direction and thereby the focus is made constant, and thus the focus control system is stabilized.

That is, even when the movable part 2 collides with the fixed part during the transfer, the focus control system is not likely to be abnormal.

While in this third embodiment the case of transferring the optical head 9 having a plurality of focusing lenses is described, this third embodiment may be applied to the case of using the optical head 540 having one focusing lens shown in FIG. 23 which is described with respect to the background art, and the same effects as described above can be obtained. In this case, the output signal of the power amplification circuit 20 in FIG. 9 is forwarded to the focusing coil 533 in FIG. 23. The output signal of the power amplification circuit 56 in FIG. 9 is forwarded to the tracking coil (not shown) in FIG. 23. Further, the output signal of the photodetector 511 in FIG. 23 is forwarded to the FE generation circuit 16 and the brightness level detection circuits 50 and 57 in FIG. 9.

Further, an integrated circuit for the optical head transfer device of this third embodiment includes a focus control state adjustment means for adjusting the control by the focus control block 200 according to the displacement amount of the movable part 2 in the radial direction of the optical disc, and a driving means for driving the transfer motor 13, and the control by the focus control block 200 is adjusted according to the displacement amount of the movable part 2 when the transfer motor 13 is driven.

According to the optical head transfer device of this third embodiment, the focus control state adjustment block 600 for adjusting the control state of the focus control block 200 according to the displacement amount of the movable part 2 in the tracking direction is provided, and the amplitude and offset of the focus error signal, which may vary due to the displacement of the movable part 2 in the tracking direction, are corrected. Therefore, the focus control system is stabilized, and thereby the focus control system is prevented from becoming abnormal even when the movable part is displaced and collides with the fixed part, and thus the optical head can be reliably transferred.

### Embodiment 4

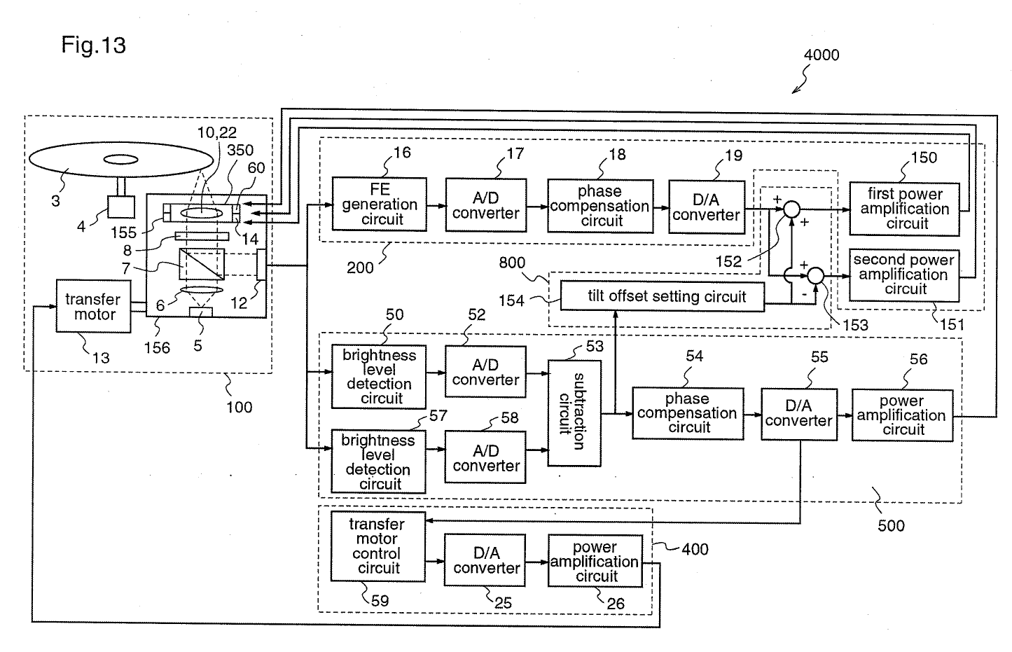

Next, an optical head transfer device 4000 according to a fourth embodiment of the present invention will be described with reference to FIG. 13.

In this fourth embodiment, the optical head transfer device 400 is provided with a tilt adjustment system which adjusts tilting of the movable part 2 in the rotation direction around the tangential direction of the optical disc, according to a lens shift signal, thereby to correct the tilting of the movable part 2 which is caused by lens shift of the movable part 2.

In this fourth embodiment, a tilt offset adjustment block 800 is provided to achieve this purpose.

In the tilt offset adjustment block 800, a lens actuator 155 is a lens actuator which is constituted to adjust tilting of the movable part 2.

First and second power amplification circuits 150 and 151 are connected to a first focusing coil and a second focusing coil of the lens actuator 155, respectively. It is assumed that the focusing coil 14 is divided into the first focusing coil 14a and the second focusing coil 14b. In FIG. 13, other constituents are identical to those of the second embodiment shown in FIG. 5(a).

The tilt offset adjustment block 800 is constituted by an addition circuit 152, a subtraction circuit 153, and a tilt offset setting circuit 154.

The addition circuit 152 adds the output signal of the tilt offset setting circuit 154 to the output signal of the A/D converter 17, and outputs the result.

The subtraction circuit 153 subtracts the output signal of the tilt offset setting circuit 154 from the output signal of the A/D converter 17, and outputs the result.

When the output value of the tilt offset setting circuit 154 is zero, the normal focus control is operated.

When the output value of the tilt offset setting circuit 154 is positive, the output value of the first power amplification circuit 150 increases, and conversely, the output value of the second power amplification circuit 151 decreases. Accordingly, the movable part 2 tilts while the position of the movable part 2 in the focusing direction is not changed.

The tilt offset setting circuit 154 outputs a predetermined value on the basis of the lens shift signal that is the output signal of the subtraction circuit 53.

When the movable part 2 of the lens actuator 155 is significantly displaced in the tracking direction, the movable part 2 tilts. So, the tilt offset setting circuit 154 outputs a set value for correcting the tilting, when the lens shift value exceeds a predetermined value.

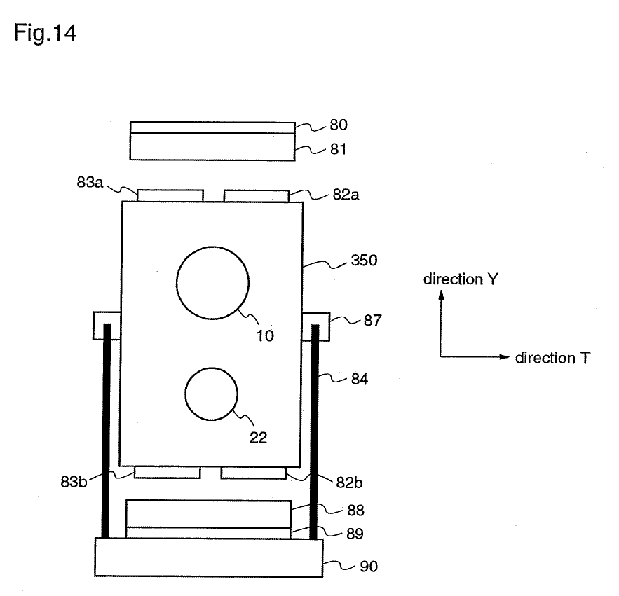

FIG. 14 shows the construction of the lens actuator 155 of the optical head transfer device according to the fourth embodiment, which is viewed from the optical disc side.

The vertical direction in FIG. 14 is the tangential direction of the track of the optical disc. Hereinafter, it is referred to as direction Y. The horizontal direction in FIG. 14 is the tracking direction. Hereinafter, it is referred to direction T. The direction perpendicular to FIG. 14 is the focusing direction.

A first focusing lens 10 and a second focusing lens 22 are mounted on a lens holder 350. A first coil 82 and a second coil 83 are attached to the two side surfaces of the movable part 2 in the direction Y, and a terminal plate 87 is attached to the two side surfaces thereof in the direction T. The terminal plate 87 is composed of plural terminal plates 87a to 87f, and a wire 84 is composed of plural wires 84a to 84f.

Accordingly, the first and second focusing lenses 10 and 22, the first focusing coil 82, the second focusing coil 83, and the terminal plate 87 constitute the movable part 2.

Each of the first focusing coil 82 and the second focusing coil 83 is a coil obtained by spirally winding a conductive linear material around an axis parallel to the direction Y.

The both end terminals of the first focusing coil 82 and the both end terminals of the second focusing coil 83 are independently connected to the first and second power amplification circuits 150 and 151, respectively, through the plural terminal plates 87a, 87b, 87c, and 87d and the plural wires 84a, 84b, 84c, and 84d.

Further, the both end terminals of the tracking coil are similarly connected to the power amplification circuit 56 through the plural terminal plates 87e and 87f and the plural wires 84e and 84f, although not shown in the figure.

The first focusing coil 82 comprises coils 82a and 82b which are connected in series. Likewise, the second focusing coil 83 comprises coils 83a and 83b which are connected in series.

First and second magnets 81 and 88 are heteropolar-magnetized in two areas having a line in the direction T as a boundary.

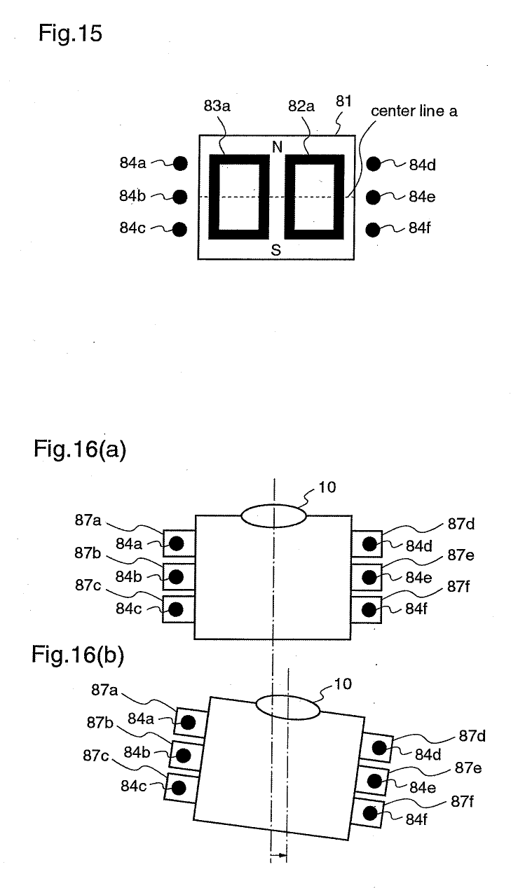

FIG. 15 is a diagram illustrating the first magnet 81, the first focusing coil 82a, and the second focusing coil 83a, which are viewed in the direction Y. The dotted line shows the heteropolar-magnetized boundary.

The first magnet 81 is disposed opposed to the first focusing coil 82a and the second focusing coil 83a at a position where the boundary of the magnetic poles thereof matches the center line a of the first focusing coil 82a and the second focusing coil 83a, and it is fixed to a yoke 80.

Likewise, the second magnet 88 is disposed opposed to the first focusing coil 82b and the second focusing coil 83b at a position where the boundary of the magnetic poles thereof matches the center line b of the first focusing coil 82b and the second focusing coil 83b, and it is fixed to a yoke 89.

The plural wires 84 comprise an elastic metal material such as beryllium copper or phosphor bronze, and wire rods or rod stocks are used.

Further, the support center of the wire 84 is set so as to approximately match the gravity center of the movable part 2.

One end of the wires 84 is connected to the terminal plate 87 of the movable part 2, while the other end thereof is connected to the fixed part 90.

The lens actuator 155 further includes coils and magnets for driving the movable part 2 in the tracking direction, which are not shown in the figure.

By applying a current to the first focusing coil 82 and the second focusing coil 83 using the first and second power amplification circuits 150 and 151, the coils generate an electromagnetic force in the focusing direction, and thereby the movable part 2 is displaced in the focusing direction.

If different currents are applied to the first focusing coil 82 and the second focusing coil 83, different electromagnetic forces are generated in the first focusing coil 82 and the second focusing coil 83, respectively, and thereby the movable part 2 tilts.

If the movable part 2 is significantly displaced toward the right side in FIG. 14 that is the tracking direction when the optical head 156 is transferred in the radial direction of the optical disc 3, the first focusing coil 82 moves to an area where the magnetic flux densities of the first magnet 81 and the second magnet 88 are reduced.

Since, in this state, the electromagnetic force that occurs in the first focusing coil 82 is reduced, the right side of the movable part 2 is lowered. That is, the movable part 2 tilts in the radial direction of the optical disc 3.

It is assumed that the neutral position in the focusing direction of the first focusing lens 10 is in a direction of approaching to the optical disc from the reference position. The reference position is a position in the state where no current is applied to the focusing coils.

That is, since the movable part 2 is closer to the optical disc 3 than the reference position, the junction of the wire 84 and the movable part 2 is closer to the optical disc 3 than the junction of the wire 84 and the fixed part.

If the electromagnetic force that occurs in the first focusing coil 82 is weakened in this state, the junction of the wire 84 and the movable part 2 tends to be apart from the optical disc 3.

Thereby, the movable part 2 tilts such that its side where the first focusing coil 82 is disposed is lowered as shown in FIG. 16(b). FIG. 16(a) shows a case where the movable part 2 does not displace in the tracking direction, i.e., the movable part 2 does not tilt.

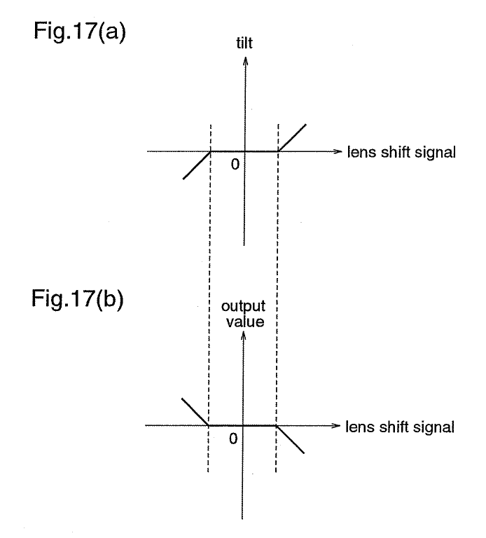

FIG. 17(a) shows examples of a lens shift signal and tilting of the movable part 2.

The tilt offset setting circuit 154 outputs a value as shown in FIG. 17(b) according to the lens shift signal to correct the tilting of the movable part 2 shown in FIG. 17(a). For example, when the movable part 2 is displaced in the tracking direction and tilted rightward as shown in FIG. 17(a), the tilt offset setting circuit 154 outputs a value that tilts the movable part 2 leftward as shown in FIG. 17(b) to correct the tilting of the movable part 2.

Accordingly, even when the movable part 2 is significantly displaced in the rightward direction that is the tracking direction as shown in FIG. 14 when the optical head 156 is transferred in the radial direction of the optical disc 3, the movable part 2 does not tilt, and thereby it is avoided that the movable part 2 collides with the fixed part to make the focus control system abnormal during the transfer.

While in this fourth embodiment the case of transferring the optical head 9 having a plurality of focusing lenses is described, this fourth embodiment 4 is also applicable to a case of using the optical head 540 having one focusing lens shown in FIG. 23 which is described with respect to the background art, and the same effects as described above can be obtained.

In this case, the output signals of the first and second power amplification circuits 150 and 151 shown in FIG. 13 are forwarded to the focusing coil 533 shown in FIG. 23. It is assumed that the focusing coil 533 is divided into a first focusing coil and a second focusing coil as described with respect to FIG. 15.

The output signal of the power amplification circuit 56 shown in FIG. 13 is forwarded to the FE generation circuit 16 and the brightness level detection circuits 50 and 57 shown in FIG. 9.

Further, an integrated circuit for the lens actuator of the optical head transfer device according to the fourth embodiment is constituted such that the respective current values supplied to the first focusing coil 14a and the second focusing coil 14b are adjusted according to the displacement amount of the movable part 2 in the direction perpendicular to the optical axis, thereby to drive the movable part 2 in the tilting direction that is the rotation direction around the tangential direction.

According to the optical head transfer device of this fourth embodiment, the tilt adjustment block 800 which adjusts tilting of the movable part 2 in the rotation direction around the tangential direction of the optical disc according to the lens shift signal is provided, and tilting of the movable part 2 which occurs due to lens shift of the movable part 2 is corrected. Therefore, tilting of the movable part which occurs while transferring the optical head is reduced, and thereby the movable part is prevented from being displaced to collide with the fixed part, and thus the optical head can be reliably transferred.

### Embodiment 5

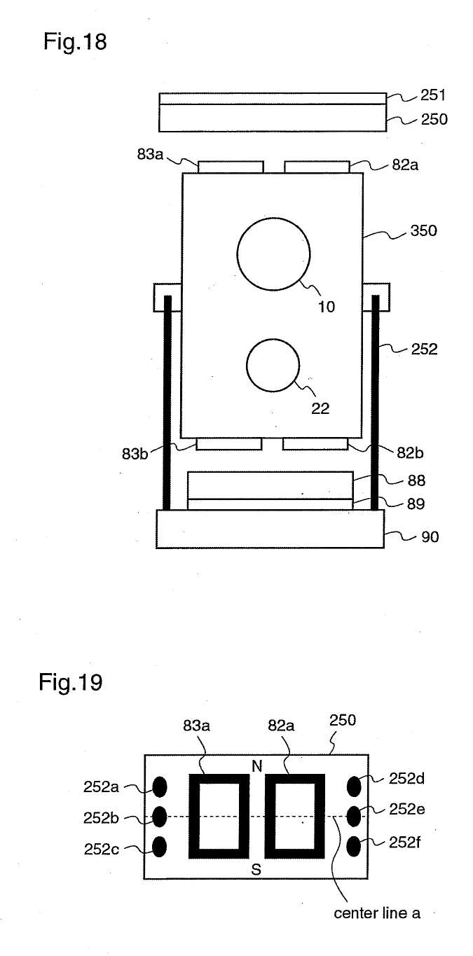

FIG. 18 is a diagram illustrating the construction of a lens actuator in an optical head transfer device according to a fifth embodiment of the present invention, which is viewed from the optical disc side.

In this fifth embodiment, the width of the first magnet 250 is larger than that of the second magnet 88 relative to the lens actuator 155 of the fourth embodiment shown in FIG. 14.

Likewise, the width of the yoke 251 is also increased. Further, as shown in FIG. 19, the wire 252 has a cross section of ellipse with its longitudinal axis in the focusing direction. Other constituents are identical to those shown in FIG. 14.

As described in the fourth embodiment, when the movable part 2 is significantly displaced in the tracking direction when the optical head is transferred in the radial direction of the optical head, the movable part 2 tilts.

However, since the width of the first magnet 250 is made larger than that of the second magnet 88, there is no reduction in the electromagnetic force that occurs in the first focusing coil 82a. Accordingly, the tilting of the movable part 2 is reduced when the optical head is transferred. Since the width of the second magnet 88 is restricted by the wire 252, it cannot be increased.

Further, since the cross section of the wire 252 as a bar-shaped elastic support member is an ellipse having its longitudinal axis in the focusing direction, the movable part 2 is not likely to tilt even when the movable part 2 is displaced in the tracking direction. Accordingly, the movable part 2 does not tilt.

Accordingly, the movable part 2 does not tilt even if the movable part 2 is significantly displaced rightward in FIG. 18 which is the tracking direction when the optical head is transferred in the radial direction of the optical disc, thereby avoiding that the movable part 2 collides with the fixed part to make the focus control system abnormal during the transfer.

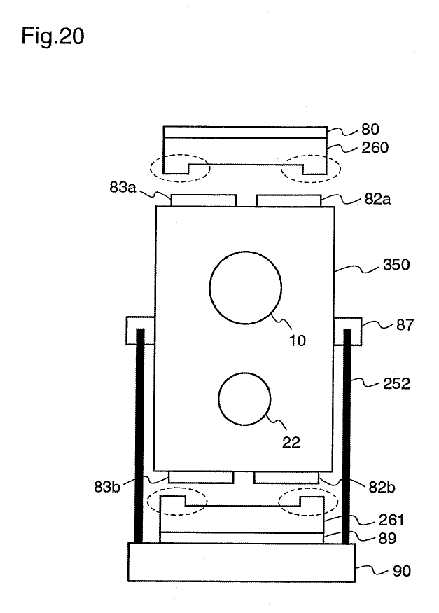

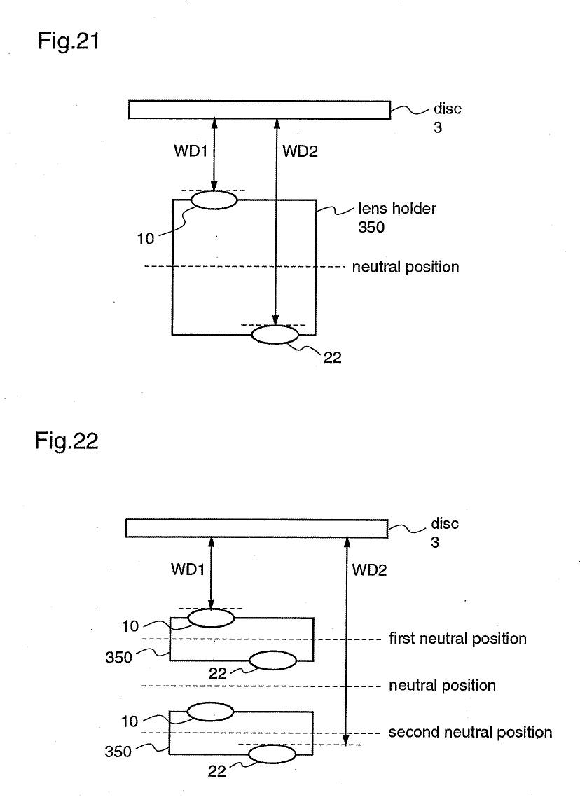

While in this fifth embodiment the width of the first magnet 250 which is not restricted by the wire 252 is increased, it may be constituted such that the shapes of the first magnet 260 and the second magnet 261 may be changed as shown in the regions enclosed by the dotted lines in FIG. 20 to change the spaces between the magnets and the focusing coils.

Further, when the movable part 2 is significantly displaced rightward in FIG. 20 which is the tracking direction, the first focusing coil 82 is displaced toward the convex portions of the first magnet 260 and the second magnet 261. Since the space between the magnet and the coil is narrowed in this position, the electromagnetic force is not reduced.

Further, instead of narrowing the space between the magnet and the coil, the magnetization of the magnet may be made stronger in the outer circumference part of the magnet than in the inner circumference part thereof with the same effect as described above.

Further, while in this fifth embodiment the lens actuator used in the optical head 9 having a plurality of focusing lenses is described, this fifth embodiment can also be applied to the lens actuator having one focusing lens which is used in the optical head 540 shown in FIG. 23 described with respect to the background part, and the same effect as described above can be achieved.

According to the optical head transfer device of this fifth embodiment, the lens actuator is constituted such that, in contrast to the lens actuator 155 of the fourth embodiment shown in FIG. 14, the width of the first magnet 250 is made larger than that of the second magnet 88, and similarly, the width of the yoke 251 is also increased, and further, the wire 252 has a cross section of ellipse with its longitudinal axis in the focusing direction. Therefore, tilting of the movable part which occurs while transferring the optical head can be reduced, and thereby the movable part is prevented from being displaced to collide with the fixed part, and the optical head can be reliably transferred.

### INDUSTRIAL APPLICABILITY

The optical head transfer device, the integrated circuit for the optical head transfer device, the focusing lens driving device, and the integrated circuit for the focusing lens driving device according to the present invention have the effect that the movable part of the lens actuator is prevented from colliding with the fixed part and thereby the optical head can be reliably transferred, and these are useful as an optical head transfer device for transferring an optical head which reproduces or records information in an optical disc device which reproduces information from an optical disc or records information in an optical disc, as well as an integrated circuit for the optical head transfer device.

1. An optical head transfer device for transferring an optical head which projects a light beam onto an information surface of an optical disc through a focusing lens which is selected among a plurality of focusing lenses which are held by a movable part, as one corresponding to the thickness of a light transmissive layer of the optical disc, comprising:
a focus control means for displacing the movable part so that the focusing state of the light beam is in a predetermined state;
a displacement means for displacing the movable part so that the light beam traverses tracks formed on the information surface;
a transfer means for transferring the displacement means in the radial direction of the optical disc; and
an abnormality detection means for detecting abnormality of the focus control means;
wherein the acceleration of the transfer means is lowered when abnormality of the focus control means is detected by the abnormality detection means while driving the transfer means.

2. An optical head transfer device for transferring an optical head which projects a light beam onto an information surface of an optical disc through a focusing lens which is selected among a plurality of focusing lenses which are held by a movable part, as one corresponding to the thickness of a light transmissive layer of the optical disc, comprising:
a focus control means for displacing the movable part so that the focusing state of the light beam is in a predetermined state;
a displacement means for displacing the movable part so that the light beam traverses tracks formed on the information surface;
a transfer means for transferring the displacement means in the radial direction of the optical disc; and
a displacement amount control means for detecting a displacement amount of the movable part in the radial direction of the optical disc so as to decrease the displacement amount of the movable part;
wherein said transfer means is driven in a state where the displacement amount control means is operated.

3. An optical head transfer device for transferring an optical head which projects a light beam onto an information surface of an optical disc through a focusing lens which is selected among a plurality of focusing lenses which are held by a movable part, as one corresponding to the thickness of a light transmissive layer of the optical disc, comprising:
a focus control means for displacing the movable part so that the focusing state of the light beam is in a predetermined state;
a displacement means for displacing the movable part so that the light beam traverses tracks formed on the information surface;
a transfer means for transferring the displacement means in the radial direction of the optical disc; and
a displacement amount control means for detecting a displacement amount of the movable part in the radial direction of the optical disc so as to decrease the displacement amount of the movable part;
wherein the acceleration of the transfer means is lowered in a state where the displacement amount control means is not operated than in the state where it is operated.

4. An optical head transfer device for transferring an optical head which projects a light beam onto an information surface of an optical disc through a focusing lens held by a movable part, while switching light beams emitted from plural light sources of different wavelengths according to the thickness of a light transmissive layer of the optical disc, comprising:
a focus control means for displacing the movable part so that the focusing state of the light beam is in a predetermined state;
a displacement means for displacing the movable part so that the light beam traverses tracks formed on the information surface;
a transfer means for transferring the displacement means in the radial direction of the optical disc; and
an abnormality detection means for detecting abnormality of the focus control means;
wherein the acceleration of the transfer means is lowered when abnormality of the focus control means is detected by the abnormality detection means while driving the transfer means.

5. An optical head transfer device for transferring an optical head which projects a light beam onto an information surface of an optical disc through a focusing lens held by a movable part, while switching light beams emitted from plural light sources of different wavelengths according to the thickness of a light transmissive layer of the optical disc, comprising:
a focus control means for displacing the movable part so that the focusing state of the light beam is in a predetermined state;
a displacement means for displacing the movable part so that the light beam traverses tracks formed on the information surface;
a transfer means for transferring the displacement means in the radial direction of the optical disc; and
a displacement amount control means for detecting a displacement amount of the movable part in the radial direction of the optical disc so as to decrease the displacement amount of the movable part;
wherein said transfer means is driven in the state where the displacement amount control means is operated.

6. An optical head transfer device for transferring an optical head which projects a light beam onto an information surface of an optical disc through a focusing lens held by a movable part, while switching light beams emitted from plural light sources of different wavelengths according to the thickness of a light transmissive layer of the optical disc, comprising:
a focus control means for displacing the movable part so that the focusing state of the light beam is in a predetermined state;
a displacement means for displacing the movable part so that the light beam traverses tracks formed on the information surface;
a transfer means for transferring the displacement means in the radial direction of the optical disc; and
a displacement amount control means for detecting a displacement amount of the movable part in the radial direction of the optical disc so as to decrease the displacement amount of the movable part;
wherein the acceleration of the transfer means is lowered in the state where the displacement amount control means is not operated than in the state where it is operated.

7. An integrated circuit for an optical head transfer device for transferring an optical head which projects a light beam onto an information surface of an optical disc through a focusing lens which is selected among a plurality of focusing lenses which are held by a movable part, as one corresponding to the thickness of a light transmissive layer of the optical disc,
said optical head transfer device including:
a focus control means for displacing the movable part so that the focusing state of the light beam is a predetermined state;
a displacement means for displacing the movable part so that the light beam traverses tracks formed on the information surface; and
a transfer means for transferring the displacement means in the radial direction of the optical disc; and
said integrated circuit including:
an abnormality detection means for detecting abnormality of the focus control means;
a drive means for driving the transfer means; and
said drive means being controlled so as to lower the acceleration of the transfer means when abnormality of the focus control means is detected by the abnormality detection means while driving the transfer means by the drive means.

8. An integrated circuit for an optical head transfer device for transferring an optical head which projects a light beam onto an information surface of an optical disc through a focusing lens which is selected among a plurality of focusing lenses which are held by a movable part, as one corresponding to the thickness of a light transmissive layer of the optical disc,
said optical head transfer device including:
a focus control means for displacing the movable part so that the focusing state of the light beam is a predetermined state;
a displacement means for displacing the movable part so that the light beam traverses tracks formed on the information surface;
a transfer means for transferring the displacement means in the radial direction of the optical disc; and
a displacement amount control means for detecting a displacement amount of the movable part in the radial direction of the optical disc so as to decrease the displacement amount of the movable part; and
said integrated circuit including:
a drive means for driving the transfer means; and
said drive means being controlled so as to drive the transfer means in the state where the displacement amount control means is operated.

9. An integrated circuit for an optical head transfer device for transferring an optical head which projects a light beam onto an information surface of an optical disc through a focusing lens which is selected among a plurality of focusing lenses which are held by a movable part, as one corresponding to the thickness of a light transmissive layer of the optical disc,
said optical head transfer device including:
a focus control means for displacing the movable part so that the focusing state of the light beam is in a predetermined state;
a displacement means for displacing the movable part so that the light beam traverses tracks formed on the information surface;
a transfer means for transferring the displacement means in the radial direction of the optical disc; and
a displacement amount control means for detecting a displacement amount of the movable part in the radial direction of the optical disc to decrease the displacement amount of the movable part; and
said integrated circuit including:
a drive means for driving the transfer means; and
said drive means being controlled so as to lower the acceleration of the transfer means in the state where the displacement amount control means is not operated than in the state where it is operated.

10. An integrated circuit for an optical head transfer device for transferring an optical head which projects a light beam onto an information surface of an optical disc through a focusing lens held by a movable part, while switching light beams emitted from plural light sources of different wavelengths according to the thickness of a light transmissive layer of the optical disc,
said optical head transfer device including:
a focus control means for displacing the movable part so that the focusing state of the light beam is in a predetermined state;
a displacement means for displacing the movable part so that the light beam traverses tracks formed on the information surface; and
a transfer means for transferring the displacement means in the radial direction of the optical disc; and
said integrated circuit including:
an abnormality detection means for detecting abnormality of the focus control means;
a drive means for driving the transfer means; and
said drive means being controlled so as to lower the acceleration of the transfer means when abnormality of the focus control means is detected by the abnormality detection means while driving the transfer means by the drive means.

11. An integrated circuit for an optical head transfer device for transferring an optical head which projects a light beam onto an information surface of an optical disc through a focusing lens held by a movable part, while switching light beams emitted from plural light sources of different wavelengths according to the thickness of a light transmissive layer of the optical disc,
said optical head transfer device including:
a focus control means for displacing the movable part so that the focusing state of the light beam is in a predetermined state;
a displacement means for displacing the movable part so that the light beam traverses tracks formed on the information surface;
a transfer means for transferring the displacement means in the radial direction of the optical disc; and
a displacement amount control means for detecting a displacement amount of the movable part in the radial direction of the optical disc so as to decrease the displacement amount of the movable part; and
said integrated circuit including:
a drive means for driving the transfer means; and
said drive means being controlled so as to drive the transfer means in the state where the displacement amount control means is operated.

12. An integrated circuit for an optical head transfer device for transferring an optical head which projects a light beam onto an information surface of an optical disc through a focusing lens held by a movable part, while switching light beams emitted from plural light sources of different wavelengths according to the thickness of a light transmissive layer of the optical disc,
said optical head transfer device including:
a focus control means for displacing the movable part so that the focusing state of the light beam is in a predetermined state;
a displacement means for displacing the movable part so that the light beam traverses tracks formed on the information surface;
a transfer means for transferring the displacement means in the radial direction of the optical disc; and
a displacement amount control means for detecting a displacement amount of the movable part in the radial direction of the optical disc so as to decrease the displacement amount of the movable part; and
said integrated circuit including:
a drive means for driving the transfer means; and
said drive means being controlled so as to lower the acceleration of the transfer means in the state where the displacement amount control means is not operated than in the state where it is operated.

13. An optical head transfer device for transferring an optical head which projects a light beam onto an information surface of an optical disc through a focusing lens which is selected among a plurality of focusing lenses which are held by a movable part, as one corresponding to the thickness of a light transmissive layer of the optical disc, comprising:
a focus control means for displacing the movable part so that the focusing state of the light beam is in a predetermined state;
a displacement means for displacing the movable part so that the light beam traverses tracks formed on the information surface;
a transfer means for transferring the displacement means in the radial direction of the optical disc; and
a displacement amount control means for detecting a displacement amount of the movable part in the radial direction of the optical disc so as to decrease the displacement amount of the movable part;
wherein the transfer means is driven in the state where the displacement amount of the movable part in the radial direction of the optical disc is made zero by the displacement amount control means.

14. An optical head transfer device for transferring an optical head which projects a light beam onto an information surface of an optical disc through a focusing lens which is selected among a plurality of focusing lenses which are held by a movable part, as one corresponding to the thickness of a light transmissive layer of the optical disc, comprising:
a focus control means for displacing the movable part so that the focusing state of the light beam is in a predetermined state;
a displacement means for displacing the movable part so that the light beam traverses tracks formed on the information surface;
a transfer means for transferring the displacement means in the radial direction of the optical disc; and
an abnormality detection means for detecting abnormality of the focus control means;
wherein said transfer means is driven in the state where the focus control means is not operated, when abnormality of the focus control means is detected by the abnormality detection means while driving the transfer means.

15. An optical head transfer device for transferring an optical head which projects a light beam onto an information surface of an optical disc through a focusing lens held by a movable part, while switching light beams emitted from plural light sources of different wavelengths according to the thickness of a light transmissive layer of the optical disc, comprising:
a focus control means for displacing the movable part so that the focusing state of the light beam is in a predetermined state;
a displacement means for displacing the movable part so that the light beam traverses tracks formed on the information surface;
a transfer means for transferring the displacement means in the radial direction of the optical disc; and
a displacement amount control means for detecting a displacement amount of the movable part in the radial direction of the optical disc so as to decrease the displacement amount of the movable part;
wherein said transfer means is driven in the state where the displacement amount of the movable part in the radial direction of the optical disc is made zero by the displacement amount control means.

16. An optical head transfer device for transferring an optical head which projects a light beam onto an information surface of an optical disc through a focusing lens held by a movable part, while switching light beams emitted from plural light sources of different wavelengths according to the thickness of a light transmissive layer of the optical disc, comprising:
a focus control means for displacing the movable part so that the focusing state of the light beam is in a predetermined state;
a displacement means for displacing the movable part so that the light beam traverses tracks formed on the information surface;
a transfer means for transferring the displacement means in the radial direction of the optical disc; and
an abnormality detection means for detecting abnormality of the focus control means;
wherein said transfer means is driven in the state where the focus control means is not operated, when abnormality of the focus control means is detected by the abnormality detection means while driving the transfer means.

17. An optical head transfer device as defined in claim 14 wherein, when abnormality of the focus control means is detected, the transfer means is driven with the movable part being apart from the optical disc.

18. An optical head transfer device for transferring an optical head which projects a light beam onto an information surface of an optical disc through a focusing lens which is selected among a plurality of focusing lenses which are held by a movable part, as one corresponding to the thickness of a light transmissive layer of the optical disc, comprising:
a focus control means for displacing the movable part so that the focusing state of the light beam is in a predetermined state;
a displacement means for displacing the movable part so that the light beam traverses tracks formed on the information surface;
a transfer means for transferring the displacement means in the radial direction of the optical disc;
a displacement amount control means for detecting a displacement amount of the movable part in the radial direction of the optical disc so as to decrease the displacement amount of the movable part; and
a focus control state adjustment means for adjusting the control by the focus control means according to the displacement amount of the movable part in the radial direction of the optical disc;
wherein the control by the focus control means is adjusted according to the displacement amount of the movable part when the transfer means is driven.

19. An optical head transfer device for transferring an optical head which projects a light beam onto an information surface of an optical disc through a focusing lens held by a movable part, while switching light beams emitted from plural light sources of different wavelengths according to the thickness of a light transmissive layer of the optical disc, comprising:
a focus control means for displacing the movable part so that the focusing state of the light beam is in a predetermined state;
a displacement means for displacing the movable part so that the light beam traverses tracks formed on the information surface;
a transfer means for transferring the displacement means in the radial direction of the optical disc;
a displacement amount control means for detecting a displacement amount of the movable part in the radial direction of the optical disc so as to decrease the displacement amount of the movable part; and
a focus control state adjustment means for adjusting the control by the focus control means according to the displacement amount of the movable part in the radial direction of the optical disc;
wherein the control by the focus control means is adjusted according to the displacement amount of the movable part when the transfer means is driven.

20. An optical head transfer device as defined in claim 18 wherein said focus control state adjustment means adjusts a gain of a focus control loop.

21. An optical head transfer device as defined in claim 18 wherein said focus control state adjustment means adjusts a target value of a focus control loop.

22. An integrated circuit for an optical head transfer device for transferring an optical head which projects a light beam onto an information surface of an optical disc through a focusing lens which is selected among a plurality of focusing lenses which are held by a movable part, as one corresponding to the thickness of a light transmissive layer of the optical disc,
said optical head transfer device including:
a focus control means for displacing the movable part so that the focusing state of the light beam is in a predetermined state;
a displacement means for displacing the movable part so that the light beam traverses tracks formed on the information surface;
a transfer means for transferring the displacement means in the radial direction of the optical disc; and
a displacement amount control means for detecting a displacement amount of the movable part in the radial direction of the optical disc so as to decrease the displacement amount of movable part;
said integrated circuit including:
a drive means for driving the transfer means; and
said drive means being controlled so as to drive the transfer means in the state where the displacement amount of the movable part in the radial direction of the optical disc is made zero by the displacement amount control means.

23. An integrated circuit for an optical head transfer device for transferring an optical head which projects a light beam onto an information surface of an optical disc through a focusing lens which is selected among a plurality of focusing lenses which are held by a movable part, as one corresponding to the thickness of a light transmissive layer of the optical disc,
said optical head transfer device including:
a focus control means for displacing the movable part so that the focusing state of the light beam is in a predetermined state;
a displacement means for displacing the movable part so that the light beam traverses tracks formed on the information surface;
a transfer means for transferring the displacement means in the radial direction of the optical disc; and
an abnormality detection means for detecting abnormality of the focus control means;
said integrated circuit including:
a drive means for driving the transfer means; and
said drive means being controlled so as to drive the transfer means with the focus control means being put in the non-operating state, when abnormality of the focus control means is detected by the abnormality detection means while driving the transfer means.

24. An integrated circuit for an optical head transfer device for transferring an optical head which projects a light beam onto an information surface of an optical disc through a focusing lens which is selected among a plurality of focusing lenses which are held by a movable part, as one corresponding to the thickness of a light transmissive layer of the optical disc,
said optical head transfer device including:
a focus control means for displacing the movable part so that the focusing state of the light beam is in a predetermined state;
a displacement means for displacing the movable part so that the light beam traverses tracks formed on the information surface;
a transfer means for transferring the displacement means in the radial direction of the optical disc; and
a displacement amount control means for detecting a displacement amount of the movable part in the radial direction of the optical disc so as to decrease the displacement amount of the movable part;
said integrated circuit including:
a focus control state adjustment means for adjusting the control by the focus control means according to the displacement amount of the movable part in the radial direction of the optical disc; and
a drive means for driving the transfer means;
wherein the control by the focus control means is adjusted according to the displacement amount of the movable part when the transfer means is driven.

25. An integrated circuit for an optical head transfer device for transferring an optical head which projects a light beam onto an information surface of an optical disc through a focusing lens held by a movable part, while switching light beams emitted from plural light sources of different wavelengths according to the thickness of a light transmissive layer of the optical disc,
said optical head transfer device including:
a focus control means for displacing the movable part so that the focusing state of the light beam is in a predetermined state;
a displacement means for displacing the movable part so that the light beam traverses tracks formed on the information surface;
a transfer means for transferring the displacement means in the radial direction of the optical disc; and
a displacement amount control means for detecting a displacement amount of the movable part in the radial direction of the optical disc so as to decrease the displacement amount of the movable part;
said integrated circuit including:
a drive means for driving the transfer means; and
said drive means being controlled so as to drive the transfer means in the state where the displacement amount of the movable part in the radial direction of the optical disc is made zero by the displacement amount control means.

26. An integrated circuit for an optical head transfer device for transferring an optical head which projects a light beam onto an information surface of an optical disc through a focusing lens held by a movable part, while switching light beams emitted from plural light sources of different wavelengths according to the thickness of a light transmissive layer of the optical disc,
said optical head transfer device including:
a focus control means for displacing the movable part so that the focusing state of the light beam is in a predetermined state;
a displacement means for displacing the movable part so that the light beam traverses tracks formed on the information surface;
a transfer means for transferring the displacement means in the radial direction of the optical disc; and
an abnormality detection means for detecting abnormality of the focus control means;
said integrated circuit including:
a drive means for driving the transfer means; and
said drive means being controlled so as to drive the transfer means with the focus control means being put in the non-operating state, when abnormality of the focus control means is detected by the abnormality detection means while driving the transfer means.

27. An integrated circuit for an optical head transfer device for transferring an optical head which projects a light beam onto an information surface of an optical disc through a focusing lens held by a movable part, while switching light beams emitted from plural light sources of different wavelengths according to the thickness of a light transmissive layer of the optical disc,
said optical head transfer device including:
a focus control means for displacing the movable part so that the focusing state of the light beam is in a predetermined state;
a displacement means for displacing the movable part so that the light beam traverses tracks formed on the information surface;
a transfer means for transferring the displacement means in the radial direction of the optical disc; and
a displacement amount control means for detecting a displacement amount of the movable part in the radial direction of the optical disc so as to decrease the displacement amount of the movable part;
said integrated circuit including:
a focus control state adjustment means for adjusting the control by the focus control means according to the displacement amount of the movable part in the radial direction of the optical disc; and
a drive means for driving the transfer means;
wherein the control by the focus control means is adjusted according to the displacement amount of the movable part when the transfer means is driven.

28. An integrated circuit for an optical head transfer device as defined in claim 24, wherein said focus control state adjustment means adjusts a gain of a focus control loop.

29. An integrated circuit for an optical head transfer device as defined in claim 24, wherein said focus control state adjustment means adjusts a target value of a focus control loop.

30. A focusing lens driving device provided on an optical head which projects a light beam onto an information surface of an optical disc through a focusing lens which is selected among a plurality of focusing lenses which are held by a movable part, as one corresponding to the thickness of a light transmissive layer of the optical disc, comprising:
said movable part; and
a plurality of bar-shaped elastic support members which movably support the movable part in a light axis direction of the focusing lens and in a direction perpendicular to the light axis direction; and
each of the bar-shaped elastic support members extending along a tangential direction of the optical disc, with one end being fixed to a fixed part and the other end being connected to the movable part, and having a cross section of ellipse with its longitudinal axis in the light axis direction.

31. A focusing lens driving device provided on an optical head which projects a light beam onto an information surface of an optical disc through a focusing lens held by a movable part, while switching light beams emitted from plural light sources of different wavelengths according to the thickness of a light transmissive layer of the optical disc, comprising:
said movable part; and
a plurality of bar-shaped elastic support members which movably support the movable part in a light axis direction of the focusing lens and in a direction perpendicular to the light axis direction; and
each of the bar-shaped elastic support members extending along a tangential direction of the optical disc, with one end being fixed to a fixed part and the other end being connected to the movable part, and having a cross section of ellipse with its longitudinal axis in the light axis direction.

32. A focusing lens driving device as defined in claim 30, wherein six bar-shaped elastic support members are provided.

33. A focusing lens driving device provided on an optical head which projects a light beam onto an information surface of an optical disc through a focusing lens which is selected among a plurality of focusing lenses which are held by a movable part, as one corresponding to the thickness of a light transmissive layer of the optical disc, comprising:
said movable part;
bar-shaped elastic support members for movably supporting the movable part in a light axis direction of the focusing lens and in a direction perpendicular to the light axis direction, each of said bar-shaped elastic support member extending along a tangential direction of the optical disc, with one end being fixed to a fixed part and the other end being connected to the movable part; and
a focus driving means for driving the movable part in the light axis direction, which comprises a plurality of focusing coils that are attached to both side surfaces of the movable part in the tangential direction, and a plurality of magnets that are fixed to the fixed part at a position opposed to the plural focusing coils;
wherein the width of the magnet in the direction perpendicular to the light axis direction on the other end side of the bar-shaped elastic support members is larger than the width of the magnet in the direction perpendicular to the light axis on the fixed part side to which the bar-shaped elastic support members are connected.

34. A focusing lens driving device provided on an optical head which projects a light beam onto an information surface of an optical disc through a focusing lens held by a movable part, while switching light beams emitted from plural light sources of different wavelengths according to the thickness of a light transmissive layer of the optical disc, comprising:
said movable part;
bar-shaped elastic support members for movably supporting the movable part in a light axis direction of the focusing lens and in a direction perpendicular to the light axis direction, each of said bar-shaped elastic support member extending along a tangential direction of the optical disc, with one end being fixed to a fixed part and the other end being connected to the movable part; and
a focus driving means for driving the movable part in the light axis direction, which comprises a plurality of focusing coils that are attached to both side surfaces of the movable part in the tangential direction, and a plurality of magnets that are fixed to the fixed part at a position opposed to the plural focusing coils;
wherein the width of the magnet in the direction perpendicular to the light axis direction on the other end side of the bar-shaped elastic support members is larger than the width of the magnet in the direction perpendicular to the light axis on the fixed part side to which the bar-shaped elastic support members are connected.

35. A focusing lens driving device provided on an optical head which projects a light beam onto an information surface of an optical disc through a focusing lens which is selected among a plurality of focusing lenses which are held by a movable part, as one corresponding to the thickness of a light transmissive layer of the optical disc, comprising:
said movable part;
bar-shaped elastic support members for movably supporting the movable part in a light axis direction of the focusing lens and in a direction perpendicular to the light axis direction, each of said bar-shaped elastic support member extending along a tangential direction of the optical disc, with one end being fixed to a fixed part and the other end being connected to the movable part; and
a focus driving means for driving the movable part in the light axis direction, which comprises a plurality of focusing coils that are attached to both side surfaces of the movable part in the tangential direction, and a plurality of magnets that are fixed to the fixed part at a position opposed to the plural focusing coils;
wherein a magnetic circuit is constituted such that an electromagnetic force is increased when the focusing coils are located at the outer circumference of the magnet due to that the movable part is displaced in the direction perpendicular to the light axis.

36. A focusing lens driving device provided on an optical head which projects a light beam onto an information surface of an optical disc through a focusing lens held by a movable part, while switching light beams emitted from plural light sources of different wavelengths according to the thickness of a light transmissive layer of the optical disc, comprising:
said movable part;
bar-shaped elastic support members for movably supporting the movable part in a light axis direction of the focusing lens and in a direction perpendicular to the light axis direction, each of said bar-shaped elastic support member extending along a tangential direction of the optical disc, with one end being fixed to a fixed part and the other end being connected to the movable part; and
a focus driving means for driving the movable part in the light axis direction, which comprises a plurality of focusing coils that are attached to both side surfaces of the movable part in the tangential direction, and a plurality of magnets that are fixed to the fixed part at a position opposed to the plural focusing coils;
wherein a magnetic circuit is constituted such that an electromagnetic force is increased when the focusing coils are located at the outer circumference of the magnet due to that the movable part is displaced in the direction perpendicular to the light axis.

37. A focusing lens driving device as defined in claim 35, wherein the electromagnetic force is increased by decreasing a space between the focusing coil and the magnet.

38. A focusing lens driving device as defined in claim 35, wherein the electromagnetic force is increased by increasing the magnetic force in the vicinity of the magnets in the direction perpendicular to the light axis.

39. An integrated circuit for a focusing lens driving device provided on an optical head which projects a light beam onto an information surface of an optical disc through a focusing lens which is selected among a plurality of focusing lenses which are held by a movable part, as one corresponding to the thickness of a light transmissive layer of the optical disc,
said focusing lens driving device including:
said movable part;
bar-shaped elastic support members for movably supporting the movable part in a light axis direction of the focusing lens and in a direction perpendicular to the light axis direction, each of said bar-shaped elastic support member extending along a tangential direction of the optical disc, with one end being fixed to a fixed part and the other end being connected to the movable part;
a focus driving means for driving the movable part in the light axis direction, which comprises a plurality of focusing coils that are attached to both side surfaces of the movable part in the tangential direction, and a plurality of magnets that are fixed to the fixed part at positions opposed to the plural focusing coils; and
said plural focusing coils comprising first focusing coils and second focusing coils which are divided along the tangential direction;
said integrated circuit adjusting the respective current values supplied to the first focusing coils and the second focusing coils according to the displacement amount of the movable part in the direction perpendicular to the light axis, thereby to drive the movable part in a tilting direction that is a rotation direction around the tangential direction.

40. An integrated circuit for a focusing lens driving device provided on an optical head which projects a light beam onto an information surface of an optical disc through a focusing lens held by a movable part, while switching light beams emitted from plural light sources of different wavelengths according to the thickness of a light transmissive layer of the optical disc,
said focusing lens driving device including:
said movable part;
bar-shaped elastic support members for movably supporting the movable part in a light axis direction of the focusing lens and in a direction perpendicular to the light axis direction, each of said bar-shaped elastic support member extending along a tangential direction of the optical disc, with one end being fixed to a fixed part and the other end being connected to the movable part;
a focus driving means for driving the movable part in the light axis direction, which comprises a plurality of focusing coils that are attached to both side surfaces of the movable part in the tangential direction, and a plurality of magnets that are fixed to the fixed part at a position opposed to the plural focusing coils; and
said plural focusing coils comprising first focusing coils and second focusing coils which are divided along the tangential direction;
said integrated circuit adjusting the respective current values supplied to the first focusing coils and the second focusing coils according to the displacement amount of the movable part in the direction perpendicular to the light axis, thereby to drive the movable part in a tilting direction that is a rotation direction around the tangential direction.

41. An optical head transfer device as defined in claim 16 wherein, when abnormality of the focus control means is detected, the transfer means is driven with the movable part being apart from the optical disc.

42. An optical head transfer device as defined in claim 19 wherein said focus control state adjustment means adjusts a gain of a focus control loop.

43. An optical head transfer device as defined in claim 19 wherein said focus control state adjustment means adjusts a target value of a focus control loop.

44. An integrated circuit for an optical head transfer device as defined in claim 27, wherein said focus control state adjustment means adjusts a gain of a focus control loop.

45. An integrated circuit for an optical head transfer device as defined in claim 27, wherein said focus control state adjustment means adjusts a target value of a focus control loop.

46. A focusing lens driving device as defined in claim 31, wherein six bar-shaped elastic support members are provided.

47. A focusing lens driving device as defined in claim 36, wherein the electromagnetic force is increased by decreasing a space between the focusing coil and the magnet.

48. A focusing lens driving device as defined in claim 36, wherein the electromagnetic force is increased by increasing the magnetic force in the vicinity of the magnets in the direction perpendicular to the light axis.
